(19) United States
(12) Patent Application Publication
(10) Pub. No.: US 2009/0021380 A1
(43) Pub. Date: Jan. 22, 2009

(54) STATUS COMMUNICATION DEVICE

(76) Inventors: Tetsuya Higuchi, Ichinomiya-shi (JP); Fumika Hatta, Nagoya-shi (JP); Tomoko Motoshige, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/021,266

(22) Filed: Jan. 28, 2008

Related U.S. Application Data
(63) Continuation-in-part of application No. PCT/JP2006/314577, filed on Jul. 24, 2006.

(30) Foreign Application Priority Data
Jul. 26, 2005 (JP) 2005-215221
Jul. 27, 2005 (JP) 2005-216999
Jul. 29, 2005 (JP) 2005-220271

(51) Int. Cl. G08B 23/00

(52) U.S. Cl. 340/573.1

(57) ABSTRACT

A status communication device includes a housing, at least one measuring unit, at least one state displaying unit, a transmitting unit, a receiving unit, a data selecting unit, and a state display controlling unit. The at least one measuring unit measures biological data of a user and an ambient state of the housing. The at least one state displaying unit displays a state of the user or the ambient state of the housing. The transmitting unit transmits first measurement-related data to at least one external device. The first measurement-related data is measurement data measured by the measuring unit or data based on the measurement data. The receiving unit receives second measurement-related data from at least one external device. The data selecting unit selects one state corresponding to the second measurement-related data to display with the state displaying unit if the receiving unit receives a plurality of the second measurement-related data within a prescribed interval. The state display controlling unit controls the state displaying unit based on the second measurement-related data selected by the data selecting unit.

### CROSS REFERENCE TO RELATED APPLICATIONS

This application is a continuation-in-part of PCT/JP2006/314577 of an international application designating the United States of America filed on Jul. 24, 2006 (international filing date), and further claims priority based on 35 U.S.C section 119 to Japanese Patent Applications No. 2005-216999 filed Jul. 27, 2005, No. 2005-220271 filed Jul. 29, 2005, and No. 2005-215221 filed Jul. 26, 2005.

### TECHNICAL FIELD

The present invention relates to a status communication device and a storage medium for storing a status communication program, and particularly to a status communication device for communicating with a plurality of status communication devices and a storage medium for storing a status communication program capable of communicating with a plurality of status communication devices.

### BACKGROUND

Conventional electronic devices have been proposed for transmitting the emotions of a user using a terminal, the status of the terminal, and the like to other terminals. For example, the electronic device displays various states with a display, such as LEDs of a number equivalent to the number of states, or displays states by turning on and flashing a single display, as in a communication device disclosed in Japanese unexamined patent application publication No. H11-306445, where each state is represented by a flashing pattern.

Alternatively, a content displaying device disclosed in Japanese Patent Application Publication No. 2004-228721 sequentially displays various content distributed over a network, without requiring the user to perform any operations, by displaying part of the content for a fixed interval and automatically switching the display to different parts of the content, each displayed at the fixed interval, so that the user can view a larger amount of distributed content.

### SUMMARY

However, the conventional status communication device for receiving states of other status communication devices and displaying these states on a display using a different display format for each type of state can be problematic when states are received from a plurality of status communication devices. Specifically, the content displaying apparatus disclosed in Japanese Patent Application Publication No. 2004-228721 uses the method of displaying each state in sequence for a fixed interval, but a great amount of time is required to display all states. Shortening the interval in which the states are displayed can be confusing to the user because the display switches too frequently.

Therefore, it is an object of the present invention to provide a status communication device and a storage medium for storing-a status communication program capable of displaying the states of other status communication devices in a way that is not confusing to the user, even when the status communication device is communicating with a plurality of other status communication devices.

In order to attain the above and other objects, the invention provides a status communication device including a housing, at least one measuring unit, at least one state displaying unit, a transmitting unit, a receiving unit, a data selecting unit, and a state display controlling unit. The at least one measuring unit measures biological data of a user and an ambient state of the housing. The at least one state displaying unit displays a state of the user or the ambient state of the housing. The transmitting unit transmits first measurement-related data to at least one external device. The first measurement-related data is measurement data measured by the measuring unit or data based on the measurement data. The receiving unit receives second measurement-related data from at least one external device. The data selecting unit selects one state corresponding to the second measurement-related data to display with the state displaying unit if the receiving unit receives a plurality of the second measurement-related data within a prescribed interval. The state display controlling unit controls the state displaying unit based on the second measurement-related data selected by the data selecting unit.

According to another aspect, the invention also provides a storage medium storing a status communication program readable by a computer, the status communication program including:

instructions for measuring biological data of a user and an ambient state of the computer;

instructions for displaying the state of the user or the ambient state of the computer on a state displaying unit;

instructions for transmitting first measurement-related data, which is measurement data measured by the measuring instructions or data based on the measurement data, to at least one external device;

instructions for receiving second measurement-related data from at least one external device in a receiving unit;

instructions for controlling the state displaying unit based on the second measurement-related data; and

instructions for selecting one state corresponding to the second measurement-related data to display with the state displaying unit if the receiving unit receives the plurality of the second measurement-related data within a prescribed interval;

wherein the controlling instructions include controlling the state displaying unit based on the second measurement-related data selected by the data selecting unit.

### BRIEF DESCRIPTION OF THE DRAWINGS

In the drawings:

FIG. 1 is an explanatory diagram conceptually illustrating a structure of a status display system using status communication devices according to a first embodiment;

FIG. 2 is a top view of the status communication device;

FIG. 3 is a bottom view of the status communication device;

FIG. 4 is a block diagram showing an electrical structure of the status communication device;

FIG. 5 is a table conceptually illustrating the structure of an output data storage area provided in ROM for a first state displaying method;

FIG. 6 is an explanatory diagram conceptually illustrating a configuration of storage areas in RAM according to the first state displaying method;

FIG. 7 is a table conceptually illustrating a structure of a reception count storage area in RAM;

FIG. 8 is a flowchart illustrating steps in a main reception process executed by the status communication device;

FIG. 9 is a flowchart illustrating steps in a reception process performed during the main reception process;

FIG. 10 is a flowchart illustrating steps in a determination process executed during the reception process;

FIG. 11 is a flowchart illustrating steps in a main outputting process;

FIG. 12 is a flowchart illustrating steps in another data outputting process executed during the main outputting process;

FIG. 13 is an explanatory diagram conceptually illustrating a configuration of storage areas in RAM of the status communication device according to a second state displaying method;

FIG. 14 is a table conceptually illustrating a structure of a level storage area provided in ROM for the second state displaying method;

FIG. 15 is a flowchart illustrating steps in a determination process according to the second state displaying method;

FIG. 16 is an explanatory diagram conceptually showing a configuration of storage areas in RAM for a third state displaying method;

FIG. 17 is a table showing a structure of a level storage area provided in ROM for the third state displaying method;

FIG. 18 is a flowchart illustrating steps in the determination process of the third state displaying method;

FIG. 19 is an explanatory diagram conceptually showing a configuration of storage areas in RAM for a fourth state displaying method;

FIG. 20 is a table showing a structure of a weighting coefficient storage area provided in ROM for the fourth state displaying method;

FIG. 21 is a flowchart illustrating steps in the determination process of the fourth state displaying method;

FIG. 22 is a flowchart illustrating steps in the reception process according to a fifth state displaying method;

FIG. 23 is an explanatory diagram conceptually illustrating a configuration of storage areas in RAM for a sixth state displaying method;

FIG. 24 is a table illustrating a structure of an ID reception count storage area provided in ROM for the sixth state displaying method;

FIG. 25 is a flowchart illustrating steps in the reception process of the sixth state displaying method;

FIG. 26 is a flowchart illustrating steps in the determination process performed during the reception process of the sixth state displaying method;

FIG. 27 is an explanatory diagram conceptually illustrating a configuration of storage areas in RAM used in a seventh state displaying method;

FIG. 28 is a table conceptually illustrating a structure of a reception interval length storage area provided in RAM shown in FIG. 27;

FIG. 29 is a table conceptually illustrating another structure of a reception interval length storage area provided in RAM shown in FIG. 27;

FIG. 30 is a table conceptually illustrating another structure of a reception interval length storage area provided in RAM shown in FIG. 27;

FIG. 31 is a flowchart illustrating steps in a reception process of the seventh state displaying method;

FIG. 32 is a flowchart illustrating steps in a table updating process performed during the reception process;

FIG. 33 is a flowchart illustrating steps in the determination process performed during the reception process;

FIG. 34 is an explanatory diagram illustrating a structure of a service providing system employing status communication devices according to a second embodiment;

FIG. 35 is an explanatory diagram showing a structure of the status communication device according to the second embodiment;

FIG. 36 is a block diagram showing an electrical structure of the status communication device according to the second embodiment;

FIG. 37 is an explanatory diagram conceptually illustrating a configuration of the storage areas in RAM according to the second embodiment;

FIG. 38 is a table conceptually illustrating a structure of a correlation storage area of RAM shown in FIG. 37;

FIG. 39 is an explanatory diagram conceptually illustrating a status table stored in a status table storage area of RAM shown in FIG. 37;

FIG. 40 is an explanatory diagram conceptually illustrating a structure of a temperature level table stored in a measurement data level table storage area of RAM shown in FIG. 37;

FIG. 41 is an explanatory diagram conceptually illustrating a structure of a heart rate level table stored in the measurement data level table storage area of RAM shown in FIG. 37;

FIG. 42 is an explanatory diagram conceptually illustrating a structure of an accelerator level table stored in the measurement data level table storage area of RAM shown in FIG. 37;

FIG. 43 is an explanatory diagram conceptually illustrating a structure of a gripping strength level table stored in the measurement data level table storage area of RAM shown in FIG. 37;

FIG. 44 is an explanatory diagram conceptually illustrating a normal emotions inference table stored in an emotions inference table storage area of RAM shown in FIG. 37;

FIG. 45 is an explanatory diagram conceptually illustrating another example of a normal emotions inference table used when including error in the measurement data;

FIG. 46 is an explanatory diagram conceptually illustrating an example of an emotions inference table for use during motor activity;

FIG. 47 is an explanatory diagram conceptually illustrating a structure of a normal environment inference table stored in an environment inference table storage area of RAM shown in FIG. 37;

FIG. 48 is an explanatory diagram conceptually illustrating a structure of an emotions output data determining table stored in an output data determining table storage area of RAM shown in FIG. 37;

FIG. 49 is an explanatory diagram conceptually illustrating a structure of an environment output data determining table stored in the output data determining table storage area of RAM shown in FIG. 37;

FIG. 50 is a flowchart illustrating steps in a main process executed by the status communication device according to the second embodiment;

FIG. 51 is a flowchart illustrating steps in a sensor value acquisition process executing during the main process in FIG. 50;

FIG. 52 is a flowchart showing a variation of the sensor value acquisition process executing during the main process in FIG. 50;

FIG. 53 is a flowchart showing another variation of the sensor value acquisition process executing during the main process in FIG. 50;

FIG. 54 is a flowchart illustrating steps in the emotions/environment inferring process;

FIG. 55 is a flowchart illustrating steps in a variation of the emotions/environment inferring process;

FIG. 56 is a flowchart illustrating steps in another variation of the emotions/environment inferring process;

FIG. 57 is an explanatory diagram of a status communication device according to a third embodiment;

FIG. 58 is a block diagram showing an electrical structure of the status communication device according to the third embodiment;

FIG. 59 is a cross-sectional view of a pressure sensor in the status communication device according to the third embodiment;

FIG. 60 is a drive circuit diagram showing the pressure sensor configured of membrane switches SW and showing an LED for indicating when the membrane switches conduct electricity;

FIG. 61 is an explanatory diagram showing the correspondence between the pressure sensor and LEDs for sensor display;

FIG. 62 is an explanatory diagram showing storage areas of RAM in the status communication device according to the third embodiment;

FIG. 63 is an explanatory diagram showing a configuration of a membrane switch output storage area in RAM shown in FIG. 62;

FIG. 64 is an explanatory diagram showing an inference table stored in an inference table storage area of RAM shown in FIG. 62;

FIG. 65 is an explanatory diagram showing an output table stored in an output table storage area of RAM shown in FIG. 62;

FIG. 66 is a flowchart illustrating steps in a main routine of a pressure sensor process;

FIG. 67 is a flowchart illustrating steps in a subroutine of the pressure sensor process for detecting the presence of a finger;

FIG. 68 is a flowchart illustrating steps in a subroutine of the pressure sensor process for detecting movement of the finger;

FIG. 69 is a flowchart illustrating steps in a subroutine of the pressure sensor process for determining the amount of pressure applied;

FIG. 70 is a flowchart illustrating steps in a subroutine of the pressure sensor process for determining the speed of finger movement;

FIG. 71 is a flowchart illustrating steps in a subroutine of the pressure sensor process for determining moving pressure; and

FIG. 72 is a flowchart illustrating steps in an inference data creation process.

### DETAILED DESCRIPTION

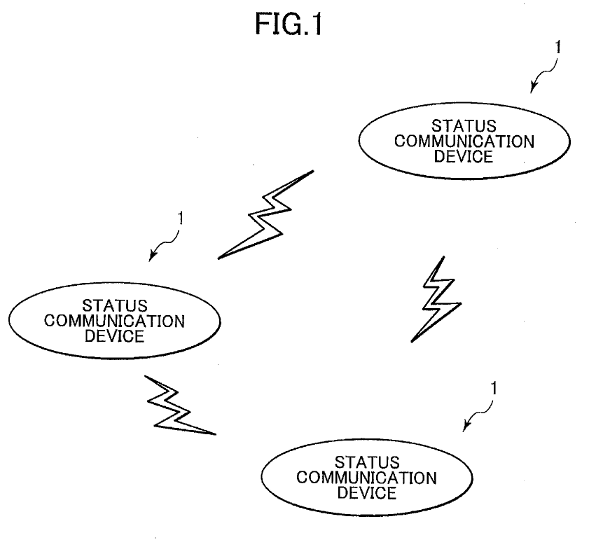

Next, a status communication device and a storage medium for storing a status communication program according to the present invention will be described while referring to the accompanying drawings. First, a status communication device 1 according to a first embodiment will be described with reference to FIGS. 1 through 4.

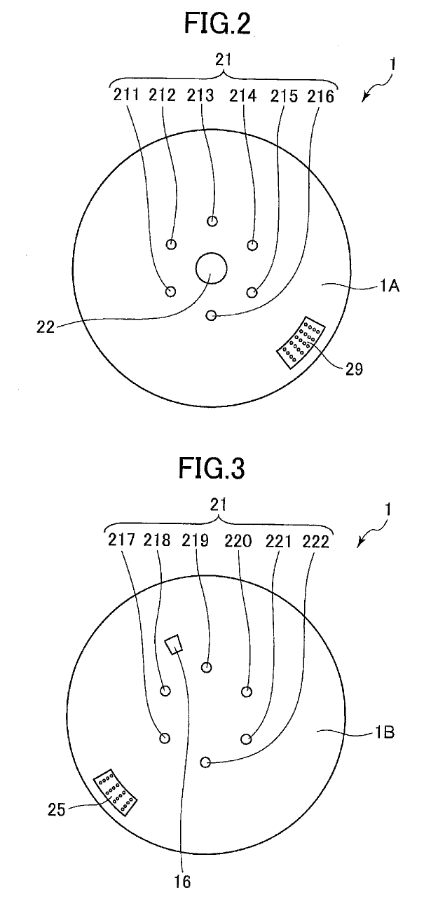

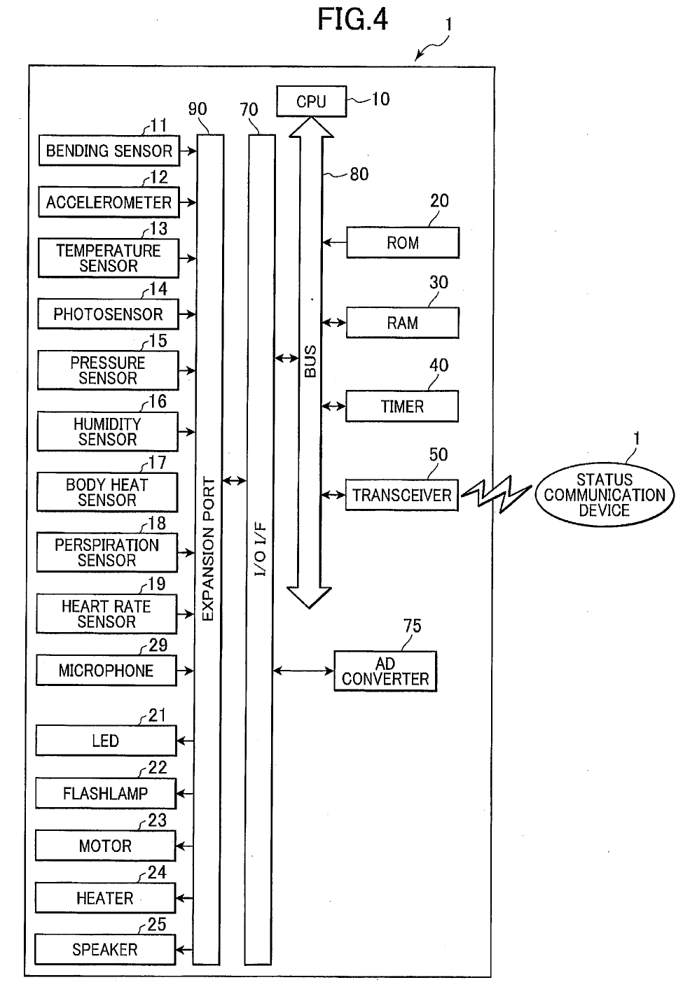

FIG. 1 is an explanatory diagram conceptually illustrating the structure of a status display system using status communication devices 1 according to the preferred embodiment. FIG. 2 is a top view of the status communication device 1, and FIG. 3 is a bottom view of the status communication device 1. FIG. 4 is a block diagram showing the electrical structure of the status communication device 1.

As shown in FIG. 1, the status communication device 1 can communicate with a similar status communication device 1 when in the same vicinity. Further, the status communication device 1 is capable of displaying its own status, a status of a person using the status communication device 1, statuses of other status communication devices 1 with which the status communication device 1 communicates, and statuses of the people using the other status communication devices 1. As shown in FIGS. 2 and 3, the status communication device 1 is spherical in shape and small enough to fit in a palm of one's hand. The status communication device 1 houses a substrate having a CPU 10 for controlling the status communication device 1, a ROM 20, a RAM 30, and the like (see FIG. 4). Various modules, such as sensors and actuators are provided on a surface of the status communication device 1 and the aforementioned substrate.

Next, the electrical structure of the status communication device 1 will be described with reference to FIG. 4. As mentioned above, the status communication device 1 is controlled by the CPU 10 provided therein. The CPU 10 is connected via a bus 80 to the RAM 30 for temporarily storing various data, the ROM 20 for storing control programs and the like, a timer 40 for counting time, a transceiver 50 for exchanging data with another status communication device 1 and the like. The ROM 20 also stores a status communication program described later that is executed by the status communication device 1. The various modules provided on the surface of the status communication device 1 are connected to the CPU 10 via an expansion port 90, an I/O interface 70, and the bus 80. An AD converter 75 is connected to the I/O interface 70 for converting sensor output value to digital data. A battery (not shown) supplies power to the status communication device 1. The status communication device 1 may also be provided with a communication unit for communicating with a base station on a wireless network to connect to the Internet, and a port for connecting to a personal computer (such as a USB port for connecting a USB cable) and may be capable of communicating with other status communication devices 1 via the Internet, connecting to and exchanging data with servers on the Internet, and exchanging data with personal computers.

The modules provided on the status communication device 1 for measuring the state of the status communication device 1 include a bending sensor 11, an accelerometer 12, a temperature sensor 13, a photosensor 14, a pressure sensor 15, a humidity sensor 16, and a microphone 29. Other modules provided on the status communication device 1 for measuring the state of the user are a body heat sensor 17, a perspiration sensor 18, and a heart rate sensor 19.

The bending sensor 11 measures deformation in the surface of the status communication device 1 using a strain gauge to determine whether the user is holding the status communication device 1 or to measure the amount of force the user is applying when gripping the status communication device 1. The accelerometer 12 uses a piezoelectric ceramic material, changes in capacitance, and the like to measure movement of the status communication device 1, including the direction of movement and acceleration thereof, and to detect a state in which the status communication device 1 is shaken by the user and the velocity of the status communication device 1 at this time. The temperature sensor 13 employs a platinum resistance temperature detector, a thermistor, a thermocouple, or the like to indicate temperature for measuring ambient temperature around the status communication device 1. The photosensor 14 uses a phototransistor or CdS or the like to measure the intensity of light and is provided on the surface of the status communication device 1. The pressure sensor 15 includes a fixed resistor connected in series to a conductive rubber. The pressure sensor 15 measures pressure applied to the status communication device 1 by measuring a divided voltage in the conductive rubber when a specific voltage is applied so as to detect whether the user has pressed the status communication device 1 and the location of this pressure. The humidity sensor 16 is also provided on the surface of the status communication device 1 and uses ceramic and polymer material to measure the amount of moisture in the air around the status communication device 1. The microphone 29 inputs voice, sounds near the status communication device 1, and the like.

The body heat sensor 17 is a temperature indicator employing a platinum resistance temperature detector, a thermistor, a thermocouple, or the like for measuring the temperature of the user's fingers or palm touching the status communication device 1. The perspiration sensor 18 is a small humidity sensor provided on the surface of the status communication device 1 for measuring perspiration on the surface of the user's fingers or palm by measuring evaporated moisture. The perspiration sensor 18 measures the amount of perspiration in units of mg/cm²/min, measuring one cm²/min. The heart rate sensor 19 is a pressure sensor provided on the surface of the status communication device 1 for measuring the heart rate (pulse rate) of the user touching the status communication device 1 by measuring pressure of blood flow.

The status communication device 1 also includes LEDs 21, a flashlamp 22, a motor 23, a heater 24, and a speaker 25 for reporting the state of the status communication device 1 and the state of the user using the status communication device 1. The LEDs 21 can be lit in a variety of colors and brightnesses and can emit light in a desired direction (upward, downward, and the like). The flashlamp 22 emits light at various intensities. The motor 23 vibrates the status communication device 1. The heater 24 generates heat in the surface of the status communication device 1 at a low temperature, i.e., a temperature that feels warm to the user but does not burn the user's skin. The speaker 25 outputs sound.

The state reporting portions (LEDs 21) described above are provided for displaying the state of the status communication device 1 in which the device is provided and the state of the user of this status communication device 1, as well as the state of other status communication devices 1 and their users. The spherical surface of the status communication device 1 is divided into one hemispherical surface 1A (the side shown in FIG. 2) for displaying its own state, and another hemispherical surface 1B (the side shown in FIG. 3) for displaying the state of other status communication devices 1.

The following description of the preferred embodiment is an example of displaying states using the LEDs 21. The status communication device 1 includes a total of twelve LEDs 21 (LEDs 211-222), with the six LEDs 211-216 provided in the hemispherical surface 1A for displaying the state of the status communication device 1, and the six LEDs 217-222 provided in the hemispherical surface 1B for displaying the state of other status communication devices 1. The casing of the status communication device 1 is formed of a material that transmits light (a translucent plastic resin, for example). The hemispherical surface 1A side illuminates when any of the LEDs 211-216 are turned on, and the hemispherical surface 1B side illuminates when any of the LEDs 217-222 are turned on. The LEDs 211 and 217 are red, the LEDs 212 and 218 pink, the LEDs 213 and 219 yellow, the LEDs 214 and 220 white, the LEDs 215 and 221 green, and the LEDs 216 and 222 light blue, allowing states to be differentiated by color.

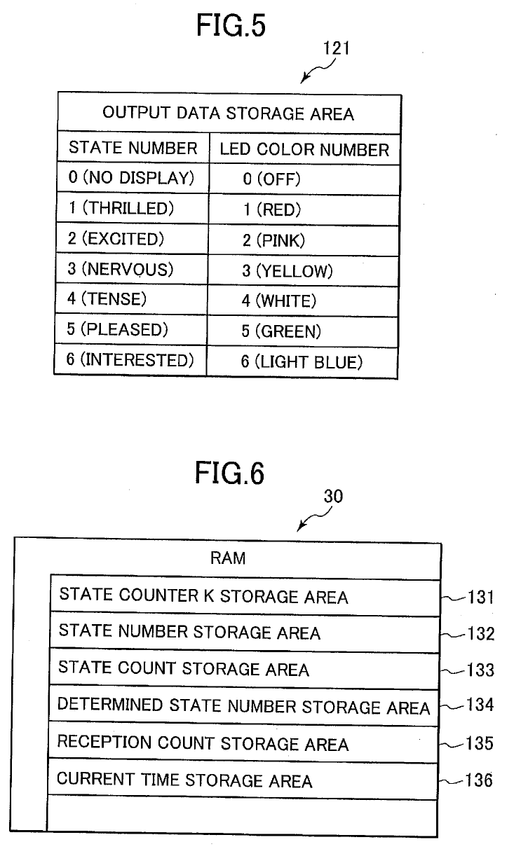

The states in the example of the preferred embodiment are “thrilled” (state no. 1), “excited” (state no. 2), “nervous” (state no. 3), “tense” (state no. 4), “pleased” (state no. 5), and “interested” (state no. 6). The ROM 20 of the status communication device 1 stores output data indicating which LED color to turn on for each state. FIG. 5 is a table conceptually illustrating the structure of an output data storage area 121 provided in the ROM 20. As shown in FIG. 5, LED colors are stored in association with each state number. Specifically, the output data storage area 121 stores color no. 1 (red) in association with state no. 1 (thrilled), color no. 2 (pink) in association with state no. 2 (excited), color no. 3 (yellow) in association with state no. 3 (nervous), color no. 4 (white) in association with state no. 4 (tense), color no. 5 (green) in association with state no. 5 (pleased), and color no. 6 (light blue) in association with state no. 6 (interested). In addition, a color no. 0 in which no LED is turned on is stored in association with a state no. 0, indicating “no display.”

Using the sensors 11-19 and 29, the status communication device 1 measures biological data for the person using the status communication device 1 (user) and measures changes in the state of the status communication device 1. The status communication device 1 determines index data described later indicating the state of the user based on the measurement data and prescribed rules. The status communication device 1 can use the index data itself or transmit this data to another status communication device 1. In the preferred embodiment, the index data is the state number indicating the state of the user.

The actuators 21-26 can report index data determined from measurement data received from the sensors 11-19 and 29 or index data received from another status communication device 1 in various formats determined according to the prescribed rules in order to render the state of the user. Specifically, the status communication device 1 in the preferred embodiment lights an LED of the color corresponding to the state number in the output data storage area 121 of the ROM 20, as described above. When displaying index data determined from its own measurement data, the status communication device 1 lights one of the LEDs 211-216 of the corresponding color. When displaying index data received from another status communication device 1, the status communication device 1 lights one of the LEDs 217-222 of the corresponding color.

Next, the case of displaying index data (state number) of another status communication device 1 will be described. If a single status communication device 1 transmits index data one time only, the status communication device 1 receiving the index data can light the LEDs 217-222 based on state number indicated by the received index data. However, if the status communication device 1 receives index data from a plurality of another status communication devices 1 or receives a plurality of index data from another status communication device 1 within a prescribed interval, the status communication device 1 cannot display the states indicated by each index data without a delay in the timing at which the states are displayed and without confusing the user as to which state is being displayed. Therefore, the status communication device and the status communication program according to the preferred embodiment select one state based on index data received within a fixed interval and displays the one state using one of the LEDs 217-222. The status communication device 1 according to the preferred embodiment has seven methods for selecting and displaying a state (first through seventh state displaying methods). The status communication program executed on the status communication device 1 according to the preferred embodiment (first through seventh state displaying methods) is configured of a main reception process (reception and determination processes) and a main outputting process (other data outputting process). The CPU 10 of the status communication device 1 executes the status communication program.

First, the first through seventh state displaying methods of the preferred embodiment will be described, after which each methods will be described in greater detail. In the first state displaying method, the status communication device 1 counts each type of state (state number) indicated by index data received within a prescribed interval (10 seconds, for example) and displays the state having the largest count using the LEDs 217-222. In the second state displaying method, the status communication device 1 assigns a level to each type of state (state number), calculates the average value of the products obtained by multiplying the received count of each state by its level, and displays the state closest to the average value of the products using the LEDs 217-222. In the third state displaying method, the status communication device 1 assigns a level to each type of state (state number) and displays the state having the greatest level using the LEDs 217-222. In the fourth state displaying method, the status communication device 1 assigns a weighting coefficient to each type of state (state number) and displays the state producing a largest product when multiplying the received count of each state by its weighting coefficient using the LEDs 217-222. In the fifth state displaying method, the status communication device 1 displays the state indicated by index data received first in the prescribed interval (10 seconds, for example) using the LEDs 217-222. In the sixth state displaying method, the status communication device 1 displays the state indicated by the index data last received from a status communication device 1 that transmitted the most index data within the prescribed interval (10 seconds, for example) using the LEDs 217-222. In the seventh state displaying method, the status communication device 1 displays the state indicated by the index data last received from the status communication device 1 that transmitted index data with the shortest interval between transfers using the LEDs 217-222.

Next, the first state displaying method performed on the status communication device 1 will be described in greater detail with reference to FIGS. 6 through 12. As described above, in the first state displaying method, the status communication device 1 counts the number of each type of state (state number) indicated by index data received within a prescribed interval (10 seconds, for example) and reports the state having a largest count by lighting the corresponding LEDs 217-222.

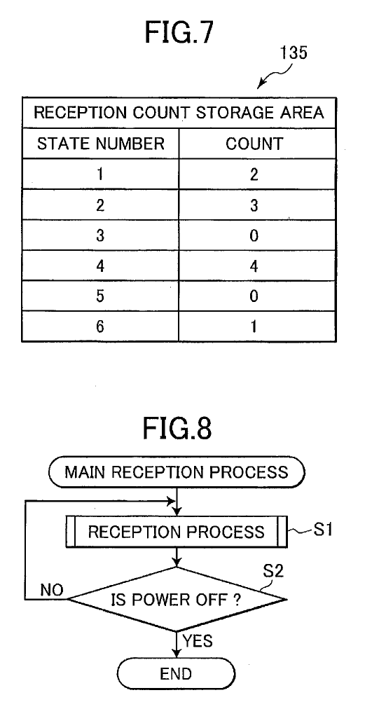

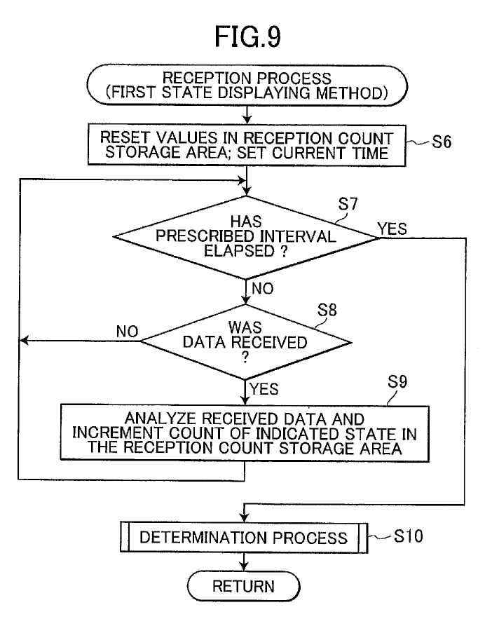

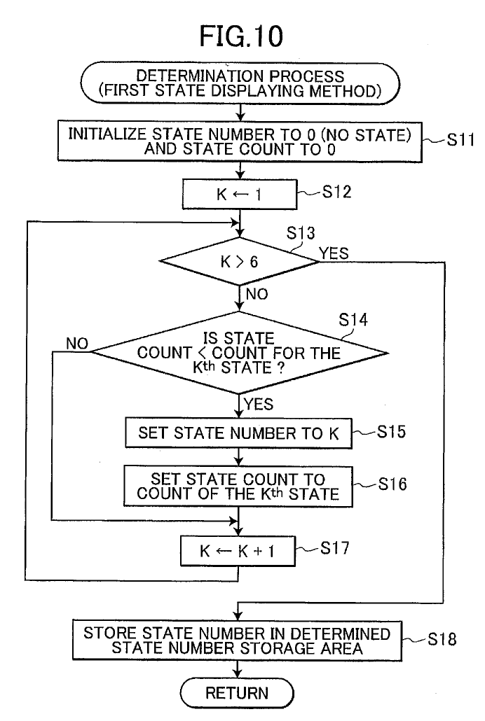

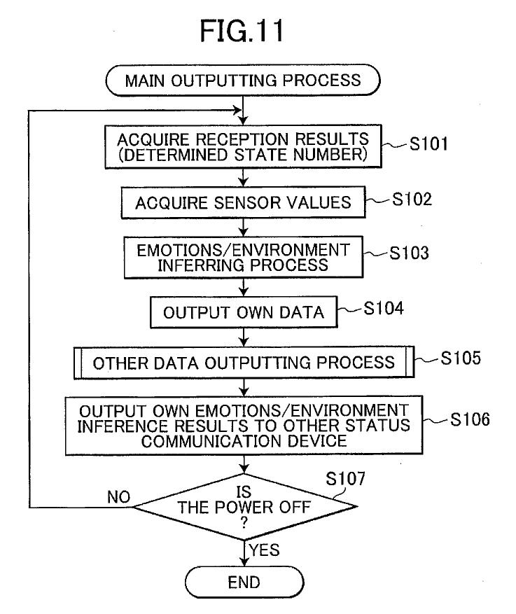

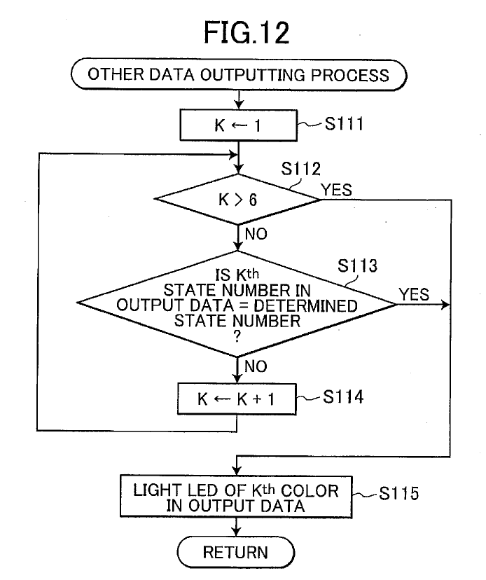

FIG. 6 is an explanatory diagram conceptually illustrating a configuration of storage areas in the RAM 30 according to the first state displaying method. FIG. 7 is a table conceptually illustrating a structure of a reception count storage area 135 in the RAM 30. FIG. 8 is a flowchart illustrating steps in the main reception process. FIG. 9 is a flowchart illustrating steps in a reception process performed during the main reception process. FIG. 10 is a flowchart illustrating steps in a determination process executed during the reception process. FIG. 11 is a flowchart illustrating steps in the main outputting process. FIG. 12 is a flowchart illustrating steps in an other data outputting process executed during the main outputting process.

First, variables used in the reception process and outputting process will be described with reference to FIG. 6. The RAM 30 is provided with a state counter K storage area 131, a state number storage area 132, a state count storage area 133, a determined state number storage area 134, the reception count storage area 135, and a current time storage area 136. The state counter K storage area 131 functions to store a state counter K that is updated when reading the number of incidents in which each state is received in the determination process. The state number storage area 132 stores a state number having a largest count when the status communication device 1 checks the reception count of each state in the determination process. The state count storage area 133 stores a reception count for a state having a largest count at the time the status communication device 1 checks the reception count for each state in the determination process. The determined state number storage area 134 stores a state number for a state having a largest count among all states. The reception count storage area 135 stores a reception count of index data corresponding to each state during the prescribed interval (see FIG. 7). The current time storage area 136 stores the time at which each prescribed interval begins.

Next, the reception count storage area 135 will be described with reference to FIG. 7. As shown in FIG. 7, values are provided in a count column for each state number. In the example of FIG. 7, a count of 2 is stored for state no. 1, 3 for state no. 2, 0 for state no. 3, 4 for state no. 4, 0 for state no. 5, and 1 for state no. 6.

Next, the main reception process will be described with reference to the flowcharts in FIGS. 8 through 10. The main reception process begins when the power to the status communication device 1 is turned on. In S1 of FIG. 8, the CPU 10 performs the reception process (see FIG. 9) and in S2 determines whether the power has been turned off. If the power has not been turned off (S2: NO), then the CPU 10 repeats the reception process in S1. The CPU 10 repeats the reception process in S1 until the power has been turned off (S2: YES). Hence, the CPU 10 continuously executes the main reception process, as well as the main outputting process (see FIG. 11) described later, while the power to the status communication device 1 is on.

Next, the reception process for the first state displaying method will be described with reference to FIGS. 9 and 10. In S6 at the beginning of the process in FIG. 9, the CPU 10 resets all values in the count column in the reception count storage area 135 to 0, acquires the current time from the timer 40 for measuring the prescribed interval (10 seconds, for example), and stores the current time in the current time storage area 136 of the RAM 30.

In S7 the CPU 10 determines whether the prescribed interval has elapsed. To make this determination, the CPU 10 acquires the current time from the timer 40, measures the elapsed time by subtracting the time stored in the current time storage area 136 from the current time, and determines whether the elapsed time is greater than or equal to the prescribed interval. If the prescribed interval has not elapsed (S7: NO), then in S8 the CPU 10 determines whether data has been received from another status communication device 1. If no data has been received (S8: NO), the CPU 10 returns to S7. However, if data has been received (S8: YES), then in S9 the CPU 10 analyzes the received data and adds a 1 to the value in the count column for the state indicated by the index data in the reception count storage area 135. Subsequently, the CPU 10 returns to S7.

When the prescribed interval has elapsed after repeating the process in S7-S9 (S7: YES), in S10 the CPU 10 performs the determination process (see FIG. 10) and subsequently returns to the main reception process.

As shown in FIG. 10, in S11 of the determination process, the CPU 10 stores 0 in the state number storage area 132 as an initial value indicating “no state” and stores 0 in the state count storage area 133 as an initial value. In S12 the CPU 10 sets the state counter K in the state counter K storage area 131 to an initial value of 1.

In S13 the CPU 10 determines whether the value of the state counter K is greater than 6, which is the total number of state types, in order to determine whether all states have been checked. If the value of the state counter K is not greater than 6 (S13: NO), then in S14 the CPU 10 determines whether the received count for the K^{th} state stored in the reception count storage area 135 is greater than the value stored in the state count storage area 133. Since the value of the state counter K is 1 at this time, and the received count of state no. 1 is 2 in the example of FIG. 7, the CPU 10 determines that the reception count is greater than the state count of 0 (S14: YES). Accordingly, in S15 the CPU 10 sets the state number to the value of the state counter K (1 at this time), and in S16 sets the state count to the reception count for state no. 1 (2 in this example). After incrementing the state counter K by 1 in S17, the CPU 10 returns to S13.

Since the value of the state counter K is now 2, which is not greater than 6 (S13: NO), the CPU 10 reads the reception count for state no. 2 (a count of 3 in the example of FIG. 7) from the reception count storage area 135. Since the reception count is greater than the state count of 2 (S14: YES), in S15 the CPU 10 sets the state number to 2 and in S16 sets the state count to 3. After incrementing the state counter K by 1 in S17, the CPU 10 returns to S13.

Since the value of the state counter K is 3 at this time, which is not greater than 6 (S13: NO), the CPU 10 reads the reception count for state no. 3 (0 in the example of FIG. 7) from the reception count storage area 135. Since 0 is not greater than the state count of 3 (S14: NO), the CPU 10 skips to S17, increments the state counter K by 1, and returns to S13. When the value of the state counter K becomes greater than 6 after repeatedly performing the process in S13-S17 (S13: YES), the CPU 10 advances to S18 and stores the value from the state number storage area 132 in the determined state number storage area 134. Subsequently, the CPU 10 returns to the reception process, and then returns to the main reception process. Since state no. 4 has the highest reception count (4 in the example of FIG. 7), the CPU 10 stores 4 in the state number storage area 132 and stores 4 in the determined state number storage area 134.

Next, the main outputting process will be described with reference to the flowcharts in FIGS. 11 and 12. In S101 at the beginning of the process, the CPU 10 acquires the state number stored in the determined state number storage area 134 as a reception result from another status communication device 1. In S102 the CPU 10 acquires measurement data from its own sensors 11-19 and 29. In S103 the CPU 10 sets index data by performing an emotions/environment inferring process for inferring its own state (environment) and the state of its user (emotions) based on the acquired sensor data. The emotions/environment inferring process will be described in detail in the second embodiment. Specifically, conditions for the values of each type of sensor are prestored in the ROM 20 in association with each type of index data. In the emotions/environment inferring process, the CPU 10 sets the index data by determining the conditions of the index data to which the sensor values acquired in S102 apply. In S104 the CPU 10 reports its own state using the LEDs 211-216 based on the index data set in the emotions/environment inferring process.

In S105 the CPU 10 performs the other data outputting process (see FIG. 12) and reports the state of the other status communication device 1 using the LEDs 217-222. In S106 the CPU 10 transmits the index data in the emotions/environment inferring process of S103 to the other status communication device 1. If the power has not been turned off (S107: NO), the CPU 10 returns to S101 and repeats the process in S101-S107, thereby continuously reporting its own state and the state of the other status communication device. However, if the power has been turned off (S107: YES), then the CPU 10 ends the main outputting process. In S106 of the sixth and seventh state displaying methods described later, the CPU 10 also transmits an ID with the index data for differentiating itself from the other status communication device 1.

In S111 of the other data outputting process shown in FIG. 12, the CPU 10 sets the state counter K to the initial value of 1. In S112 the CPU 10 determines whether the value of the state counter K is greater than 6, which is the total number of state types. If the state counter K is not greater than 6 (S112: NO), then in S113 the CPU 10 determines whether the K^{th} state number in the table of output data stored in the output data storage area 121 of the ROM 20 matches the number stored in the determined state number storage area 134 and acquired in S101. If the numbers do not match (S113: NO), then in S114 the CPU 10 increments the state counter K by 1 and returns to S112.

However, if the K^{th} state number in the output data table matches the determined state number acquired in S101 (S113: YES), then in S115 the CPU 10 lights the LED having the color specified by the K^{th} LED color number in the LED color number column of the output data storage area 121 and returns to the main outputting process. Since the determined state number is 4 in the example of FIG. 7, the CPU 10 lights the white LED 220 corresponding to the 4^{th} LED color. If the K^{th} state number in the output data table does not match the determined state number (S113: NO) and the value of the state counter K is greater than 6 (S112: YES), then in S115 the CPU 10 sets the value of the LED color number to 0, effectively, turning off all LEDs. Subsequently, the CPU 10 returns to the main outputting process.

In the first state displaying method described above, the status communication device 1 can report the state most often indicated by the received index data using the LEDs 217-222 as the state of the other status communication device 1. This method is effective for reporting the most common state when a plurality of people possess status communication devices 1 and it is desirable to learn the overall state of the status communication devices 1.

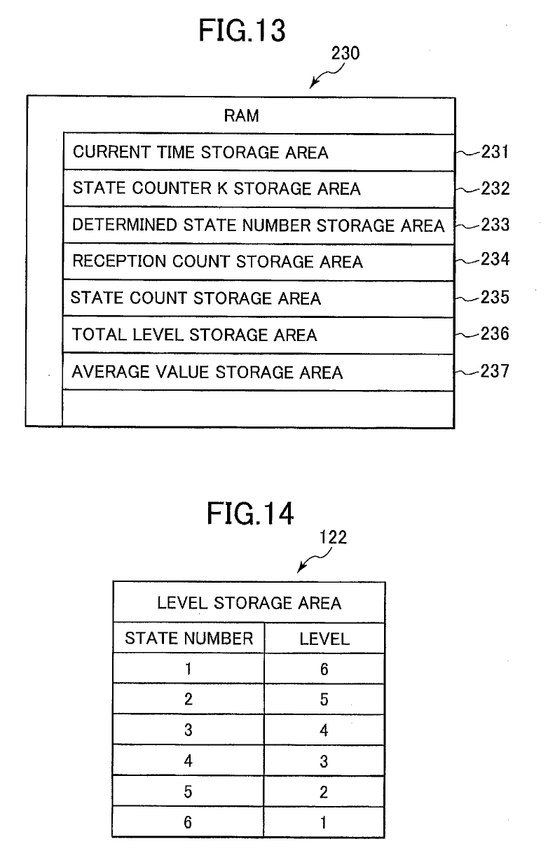

Next, the second state displaying method executed on the status communication device 1 will be described with reference to FIGS. 13 through 15. As described above, in the second state displaying method, the status communication device 1 assigns a level to each type of state (state number), calculates an average value of the products obtained by multiplying the reception count for each state by its level, and reports using the LEDs 217-222 the state closest to the average value of these products.

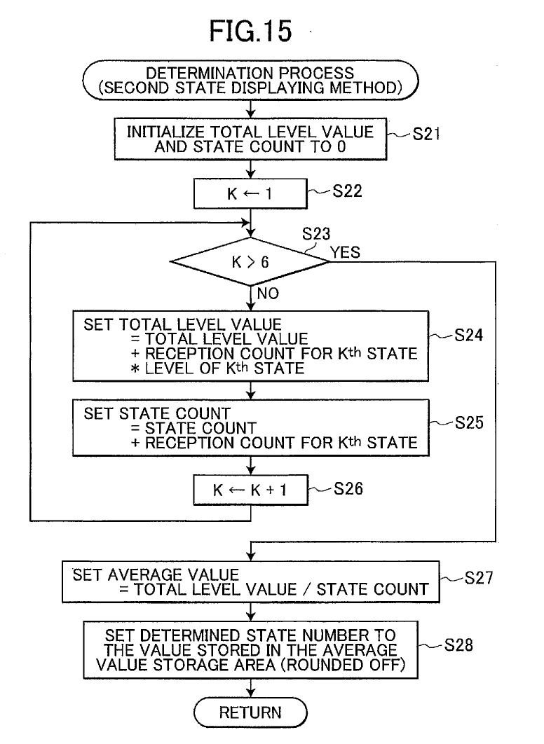

FIG. 13 is an explanatory diagram conceptually illustrating the configuration of storage areas in a RAM 230 of the status communication device 1 according to the second state displaying method. FIG. 14 is a table conceptually illustrating the structure of a level storage area 122 provided in the ROM 20 in the second state displaying method. FIG. 15 is a flowchart illustrating steps in a determination process according to the second state displaying method.

First, variables used in the reception process (see FIG. 9) and the outputting process (see FIGS. 11 and 12. will be described with reference to FIG. 13. The RAM 230 is provided with a current time storage area 231, a state counter K storage area 232, a determined state number storage area 233, a reception count storage area 234, a state count storage area 235, a total level storage area 236, an average value storage area 237, and the like.

The current time storage area 231, state counter K storage area 232, reception count storage area 234, and state count storage area 235 have the same functions as the current time storage area 136, state counter K storage area 131, reception count storage area 135 (FIG. 7), and state count storage area 133 shown in FIG. 6 for the first state displaying method. The determined state number storage area 233 stores the state number closest to the average value of products obtained by multiplying the reception count for each state number by its level. The total level storage area 236 stores a total of the level values used for calculating the average values, i.e., the sum of products obtained by multiplying the reception count for each state by its level. The average value storage area 237 stores an average value of products obtained by multiplying the reception count for each state by its level, which average value is obtained by dividing the value stored in the total level storage area 236 by the reception count.

Next, the level storage area 122 provided in the ROM 20 will be described with reference to FIG. 14. The level storage area 122 is configured of a state number column and a level column, the level column storing weighting values associated with each state number. In the example of FIG. 14, the level 6 is assigned to state no. 1, the level 5 to state no. 2, the level 4 to state no. 3, the level 3 to state no. 4, the level 2 to state no. 5, and the level 1 to state no. 6.

As in the first state displaying method, the second state displaying method also involves the main reception process, reception process, determination process, main outputting process, and other data outputting process. Since the main reception process, reception process, main outputting process, and other data outputting process in the second state displaying method are identical to those in the first state displaying method (FIGS. 8, 9, 11, and 12), only the determination process in the second state displaying method will be described with reference to FIG. 15.

In S21 of FIG. 15, the CPU 10 stores 0 in the total level storage area 236 as an initial value and 0 in the state count storage area 235 as an initial value. In S22 the CPU 10 sets the state counter K in the state counter K storage area 232 to an initial value of 1.

In S23 the CPU 10 determines whether the value of the state counter K is greater than 6, which is the total number of state types, in order to determine whether all states have been checked. If the value of the state counter K is not greater than 6 (S23: NO), then in S24 the CPU 10 reads the reception count for the K^{th} state from the reception count storage area 234, reads the level of the K^{th} state from the level storage area 122, and adds the product of the reception count and level to the value stored in the total level storage area 236. In S25 the CPU 10 adds the reception count for the K^{th} state to the value in the state count storage area 235. Since the total level value is initially 0 and the state no. 1 has a reception count of 2 in FIG. 7 and a level of 6 in the example of FIG. 14, the CPU 10 stores the value 12 (0+2×6) in the total level storage area 236. Further, after the CPU 10 adds the count 2 for state no. 1 to the initial value of 0 stored in the state count storage area 235, the state count storage area 235 now stores the value 2. Subsequently, the CPU 10 increments the state counter K by 1 in S26, so that the value of the state counter K is now 2, and returns to S23.

Since the value of the state counter K is not greater than 6 at this time (S23: NO), in S24 the CPU 10 reads the reception count for state no. 2 (3 in this example) from the reception count storage area 234 and the level from the level storage area 122 (5 in this example), adds the value 15 (3×5) to the value of 12 stored in the total level storage area 236 and stores this sum of 27 in the total level storage area 236. In S25 the CPU 10 adds the reception count of 3 to the value of 2 stored in the state count storage area 235, updating the state count storage area 235 to 5, in S26 increments the state counter K by 1, so that the state counter K is now 3, and returns to S23.

When the value of the state counter K becomes greater than 6 after repeating the above process in S23-S26 (S23: YES), the CPU 10 skips to S27 and stores a value in the average value storage area 237 obtained by dividing the value stored in the total level storage area 236 by the value stored in the state count storage area 235. In S28 the CPU 10 stores an integer value in the determined state number storage area 233 obtained by rounding off the value stored in the average value storage area 237. Subsequently, the CPU 10 returns to the reception process, and then returns to the main reception process. Since the value 40 is stored in the total level storage area 236 and the value 10 is stored in the state count storage area 235, using the examples of FIGS. 7 and 14, the CPU 10 stores the value 4.0 (40÷10) in the average value storage area 237 and, hence, stores the value 4 in the determined state number storage area 233 as the state number closest to the average value of 4.0.

Therefore, in the other data outputting process of FIG. 12 performed during the main outputting process of FIG. 11, the CPU 10 lights the LEDs 217-222 having the color corresponding to the state number determined above.

In the second state displaying method described above, the status communication device 1 assigns the level to each type of state (state number), calculates the average value of products obtained by multiplying the reception count for each state by the level of that state, and indicates the state (state number) closest the average value of the products using the LEDs 217-222. This method is effective for reporting the most common state so that the user can learn the overall state of a plurality of status communication devices 1, when a plurality of users are using status communication devices 1.

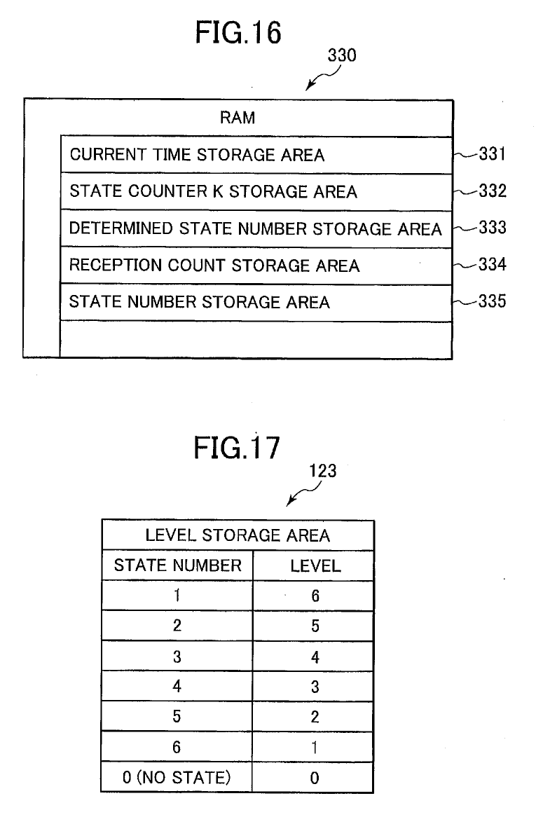

Next, the third state displaying method executed by the status communication device 1 will be described with reference to FIGS. 16 through 18. As described above, in the third state displaying method, the status communication device 1 assigns a level to each type of state (state number) and indicates the state having the highest level with the LEDs 217-222.

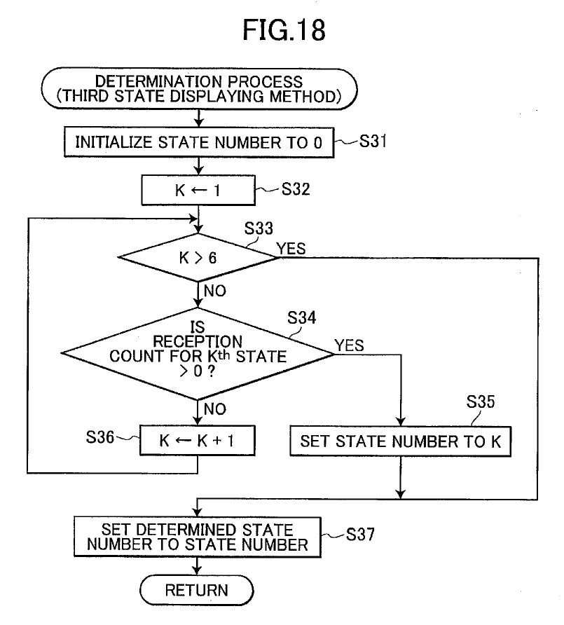

FIG. 16 is an explanatory diagram conceptually showing a configuration of storage areas in a RAM 330 for the third state displaying method. FIG. 17 is a table showing a structure of a level storage area 123 provided in the ROM 20 according to the third state displaying method. FIG. 18 is a flowchart illustrating steps in the determination process of the third state displaying method.

First, variables used in the reception process and the outputting process will be described with reference to FIG. 16. The RAM 330 includes a current time storage area 331, a state counter K storage area 332, a determined state number storage area 333, a reception count storage area 334, and a state number storage area 335.

The current time storage area 331, state counter K storage area 332, and reception count storage area 334 have the same functions as the current time storage area 136, state counter K storage area 131, and reception count storage area 135 (see FIG. 7). The determined state number storage area 333 stores a state number for the state having the highest level. The state number storage area 335 stores a state number for the state having the highest level at the time the status communication device 1 checks the reception count for each state in the determination process.

Next, the level storage area 123 provided in the ROM 20 will be described with reference to FIG. 17. The level storage area 122 is configured of a state number column and a level column, the level column storing weighting values corresponding to each state number. In the example of FIG. 17, the level 6 is assigned to state no. 1, the level 5 to state no. 2, the level 4 to state no. 3, the level 3 to state no. 4, the level 2 to state no. 5, the level 1 to state no. 6, and the level 0 to state no. 0 (no state). Hence, state no. 1 has the highest level, and the levels decrease in sequence from state no. 1 to state no. 6, followed by state no. 0.

As in the first state displaying method, the third state displaying method involves the main reception process, reception process, determination process, main outputting process, and other data outputting process. Since the main reception process, reception process, main outputting process, and other data outputting process in the third state displaying method are identical to those in the first state displaying method (see FIGS. 8, 9, 11, and 12), only the determination process of the third state displaying method will be described with reference to FIG. 18.

In S31 of FIG. 18, the CPU 10 stores 0 in the state number storage area 335 as an initial value. In S32 the CPU 10 sets the state counter K in the state counter K storage area 332 to an initial value of 1. Accordingly, the CPU 10 checks the reception count for state numbers beginning from state no. 1, which has the highest level.

In S33 the CPU 10 determines whether the value of the state counter K is greater than 6, which is the total number of state types, in order to determine whether all states have been checked. If the state counter K is not greater than 6 (S33: NO), then in S34 the CPU 10 reads the reception count for the K^{th} state from the reception count storage area 334 and determines whether this count is greater than 0. If greater than 0 (S34: YES), then there is at least one incident of the index data corresponding to state no. 1, which has the highest level. Since the state having the highest level is selected in the third state displaying method, in S35 the CPU 10 stores the value of the state counter K (1 at this time) in the state number storage area 335. In S37 the CPU 10 stores the value 1 from the state number storage area 335 in the determined state number storage area 333, and returns to the reception process in FIG. 9 and then to the main reception process in FIG. 8.

However, if the count for state no. 1 is not greater than 0 (S34: NO), indicating that the index data for this state has not been received, then in S36 the CPU 10 increments the state counter K by 1, so that the state counter K is now 2, and returns to S33. Since the value of the state counter K is not greater than 6 at this time (S33: NO), in S34 the CPU 10 reads the count for state no. 2 from the reception count storage area 334 and determines whether this count is greater than 0. If the count is greater than 0 (S34: YES), indicating that at least one incident of the index data corresponding to state no. 2, which has the next highest level, was received. Therefore, in S35 the CPU 10 stores the value of the state counter K (2 at this time) in the state number storage area 335. In S37 the CPU 10 stores the value 2 from the state number storage area 335 in the determined state number storage area 333, and subsequently returns to the reception process in FIG. 9 and then to the main reception process in FIG. 8.

However, if the count for state no. 2 is not greater than 0 (S34: NO), then the CPU 10 repeats the process in S33-S36 after incrementing the state counter K. If the value of the state counter K becomes greater than 6 without any of the states having a count greater than 0 (S33: YES), indicating that no index data has been received, then in S37 the CPU 10 stores the value 0 from the state number storage area 335, since the initial value in the state number storage area 335 remains unchanged, in the determined state number storage area 333. Subsequently, the CPU 10 returns to the reception process in FIG. 9 and then to the main reception process in FIG. 8.

Hence, in the third state displaying method described above, the status communication device 1 sets the determined state to the state having the highest level among states for which index data was received and indicates this state with the LEDs 217-222 as the state of the other status communication devices 1. Hence, the user can learn the state having the highest level among states of status communication devices 1 used by a plurality of users.

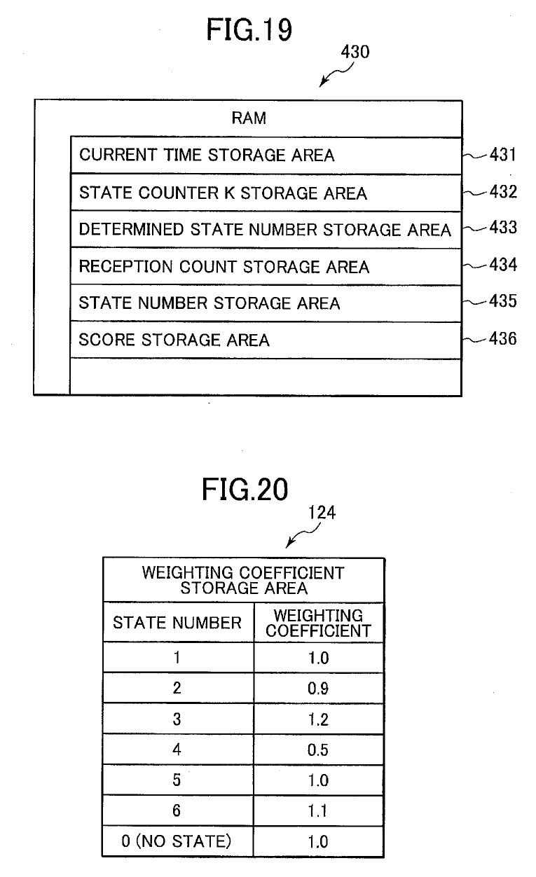

Next, the fourth state displaying method executed on the status communication device 1 will be described with reference to FIGS. 19 through 21. In the fourth state displaying method, the status communication device 1 assigns weighting coefficients to each type of state (state number) and indicates the state having the highest product obtained by multiplying the reception count of the state by its weighting coefficient using the LEDs 217-222.

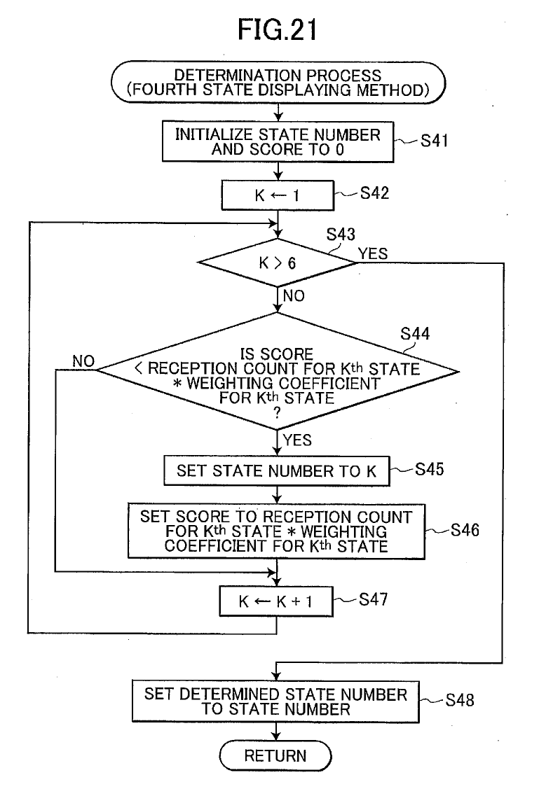

FIG. 19 is an explanatory diagram conceptually showing a configuration of storage areas in a RAM 430 used in the fourth state displaying method. FIG. 20 is a table showing a structure of a weighting coefficient storage area 124 provided in the ROM 20 for the fourth state displaying method. FIG. 21 is a flowchart illustrating steps in the determination process of the fourth state displaying method.

First, variables used in the reception process (FIG. 9) and the outputting process (FIGS. 11 and 12) will be described with reference to FIG. 19. The RAM 430 is provided with a current time storage area 431, a state counter K storage area 432, a determined state number storage area 433, a reception count storage area 434, a state number storage area 435, a score storage area 436, and the like.

The current time storage area 431, state counter K storage area 432, and reception count storage area 434 have the same functions as the current time storage area 136, state counter K storage area 131, and reception count storage area 135 (see FIG. 7). The determined state number storage area 433 stores the state number of the state having the largest product obtained by multiplying the reception count for the state by the weighting coefficient. The state number storage area 435 stores the state number of the state having the highest score at the moment that the status communication device 1 checks the reception count for each state in the determination process. The score storage area 436 stores a score, where the score is the product obtained by multiplying the reception count for a state by the weighting coefficient.

Next, the weighting coefficient storage area 124 provided in the ROM 20 will be described with reference to FIG. 20. As shown in FIG. 20, the weighting coefficient storage area 124 is configured of a state number column and a weighting coefficient column storing weighted values for each state number. In the example of FIG. 20, a weighting coefficient 1.0 is assigned to state no. 1, a weighting coefficient 0.9 to state no. 2, a weighting coefficient 1.2 to state no. 3, a weighting coefficient 0.5 to state no. 4, a weighting coefficient 1.0 to state no. 5, a weighting coefficient 1.1 to state no. 6, and a weighting coefficient 1.0 to state no. 0 (no state).

As in the first state displaying method, the fourth state displaying method involves the main reception process, reception process, determination process, main outputting process, and other data outputting process. Since the main reception process, reception process, main outputting process, and other data outputting process in the fourth state displaying method are identical to those in the first state displaying method (see FIGS. 8, 9, 11, and 12), only the determination process for the fourth state displaying method will be described with reference to FIG. 21.

In S41 of FIG. 21, the CPU 10 stores an initial value of 0 in each of the score storage area 436 and the state number storage area 435. In S42 the CPU 10 sets the state counter K in the state counter K storage area 432 to an initial value of 1.

In S43 the CPU 10 determines whether the value of the state counter K is greater than 6, which is the total number of state types, in order to determine whether all states have been checked. If the state counter K is not greater than 6 (S43: NO), then in S44 the CPU 10 reads the count for the K^{th} state from the reception count storage area 434, reads the weighting coefficient for the K^{th} state from the weighting coefficient storage area 124, and compares the product of the reception count and weighting coefficient to the value (score) stored in the score storage area 436. If the product of the count and weighting coefficient is greater than the score (S44: YES), then in S45 the CPU 10 stores the value of the state counter K in the state number storage area 435 and in S46 stores the product of the count and weighting coefficient in the score storage area 436. Since state no. 1 has a count of 2 and a weighting coefficient of 1.0 based on the examples in FIGS. 7 and 20, the CPU 10 stores the value 2.0 (2×1.0) in the score storage area 436. In S47 the CPU 10 increments the state counter K by status communication device 1, so that the state counter K is now 2, and returns to S43.

Since the value of the state counter K is now 2, which is not greater than 6 (S43: NO), in S44 the CPU 10 reads the count for state no. 2 from the reception count storage area 434 and the corresponding weighting coefficient from the weighting coefficient storage area 124 and compares the product of these values to the value stored in the score storage area 436. Since state no. 2 has a count of 3 and a weighting coefficient of 0.9, the product of the count and weighting coefficient (3×0.9=2.7) is greater than the score stored in the score storage area 436 (2.0; S44: YES). Therefore, in S45 the CPU 10 stores 2 in the state number storage area 435 and in S46 stores 2.7 in the score storage area 436. Next, the CPU 10 increments the state counter K by 1, so that the state counter K is now 3, and returns to S43.

Since the value of the state counter K is currently 3, which is not greater than 6 (S43: NO), the CPU 10 reads 0 from the reception count storage area 434 for the count of state no. 3, reads 1.2 from the weighting coefficient storage area 124 as the weighting coefficient, and compares the product of these values (0×1.2=0.0) to the value stored in the score storage area 436 (2.7). Since 0 is not greater than 2.7 (544: NO), the CPU 10 advances to S47 and increments the state counter K by status communication device 1, so that the state counter K is now 4, and subsequently returns to S43.

If the value of the state counter K becomes greater than 6 after repeating the process in S43-S47 described above (S43: YES), then the CPU 10 skips to S48 and stores the value from the state number storage area 435 in the determined state number storage area 433. Subsequently, the CPU 10 returns to the reception process of FIG. 9 and then to the main reception process of FIG. 8. Since the CPU 10 stores 2.7 in the score storage area 436 and 2 in the state number storage area 435 based on the examples in FIGS. 7 and 20, a 2 is stored in the determined state number storage area 433.

Therefore, in the other data outputting process of FIG. 12 executed during the main outputting process of FIG. 11, the CPU 10 lights the LEDs 217-222 having the color corresponding to the state number determined above.

In the fourth state displaying method described above, the status communication device 1 assigns a weighting coefficient to each type of state (state number), calculates products of the count for each state and its weighting coefficient, and indicates the state having the greatest product with the LEDs 217-222. Hence, this method is effective for reporting the most common state in order to understand the overall state of a plurality of status communication devices 1 used by a plurality of users.

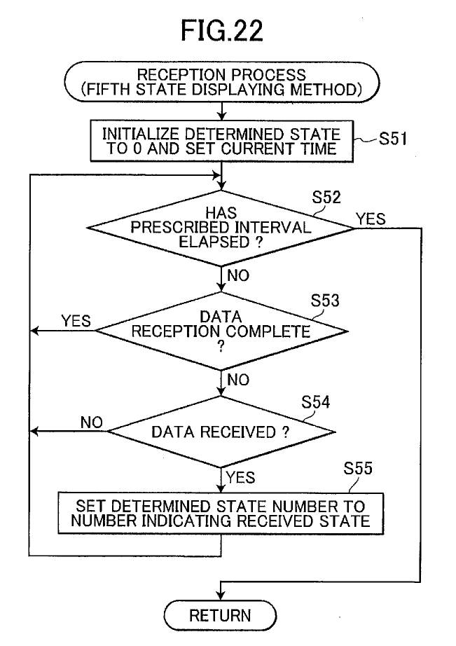

Next, the fifth state displaying method performed by the status communication device 1 will be described with reference to FIG. 22. In the fifth state displaying method, the status communication device 1 uses the LEDs 217-222 to report the state indicated by the index data initially received in the prescribed interval (10 seconds, for example).

FIG. 22 is a flowchart illustrating steps in the reception process according to the fifth state displaying method. In the fifth state displaying method, the status communication device 1 uses RAM similar to the RAM 30 used in the first state displaying method. Further, as in the first state displaying method, the fifth state displaying method involves the main reception process, reception process, main outputting process, and other data outputting process. Since the main reception process, main outputting process, and other data outputting process in the fifth state displaying method are identical to those in the first state displaying method (see FIGS. 8, 11, and 12), only the reception process in the fifth state displaying method will be described with reference to FIG. 22. In S51 at the beginning of the process in FIG. 22, the CPU 10 stores 0 in determined state number storage area 134 of the RAM 30, acquires the current time from the timer 40 in order to measure a prescribed interval (10 seconds, for example), and stores the current time in the current time storage area 136 of the RAM 30.

In S52 the CPU 10 determines whether the prescribed interval has elapsed. Specifically, the CPU 10 acquires the current time from the timer 40 and the time stored in the current time storage area 136, measures the elapsed time based on their difference, and determines whether the elapsed time is greater than or equal to the prescribed interval. If the prescribed interval has not elapsed (S52: NO), then in S53 the CPU 10 determines whether at least one instance of data has already been received from another status communication device 1. Specifically, the CPU 10 determines whether a state number other than the initial value 0 has been stored in the state number storage area 132. Since no data has been received at this time (S53: NO), in S54 the CPU 10 determines whether data was received from another status communication device 1. If data has not been received (S54: NO), the CPU 10 returns to S52.

If data has been received (S54: YES), then in S55 the CPU 10 analyzes the received data and stores index data from the state number storage area 132 of the RAM 30 (state number) in the determined state number storage area 134, and subsequently returns to S52. If the prescribed interval has not elapsed (S52: NO), then in S53 the CPU 10 determines whether at least one data reception is complete based on whether a state number other than the initial value 0 has been stored in the state number storage area 132. If the data reception is complete (S53: YES), the CPU 10 returns to S52.

If the prescribed interval has elapsed after repeating the process in S52-S55 (S52: YES), the CPU 10 returns to the main reception process.

In the subsequent other data outputting process of FIG. 12 performed during the main outputting process of FIG. 11, the CPU 10 lights the LEDs 217-222 having the color corresponding to the state number determined above.

Hence, in the fifth state displaying method described above, the status communication device 1 can use the LEDs 217-222 to report a state indicated by the first received index data.

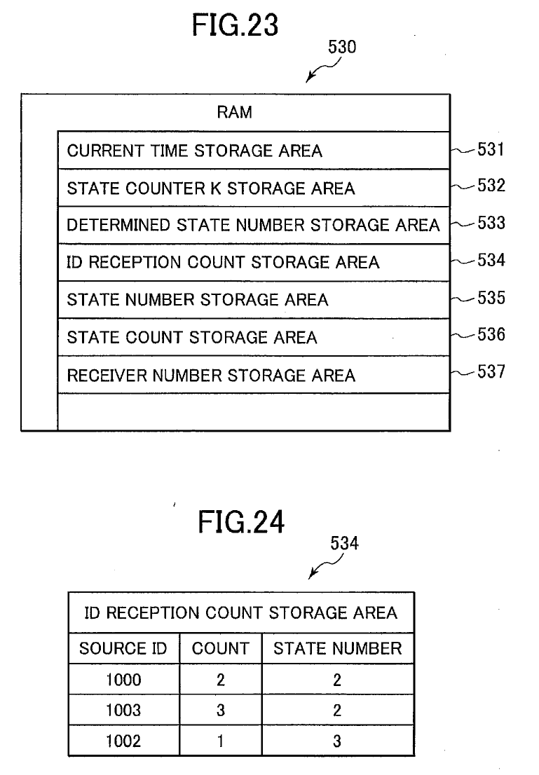

Next, the sixth state displaying method performed by the status communication device 1 will be described with reference to FIGS. 23 through 26. In the sixth state displaying method, the status communication device 1 uses the LEDs 217-222 to report a state indicated by the last index data received from the status communication device 1 that transmitted the most index data within a prescribed interval (10 seconds, for example).

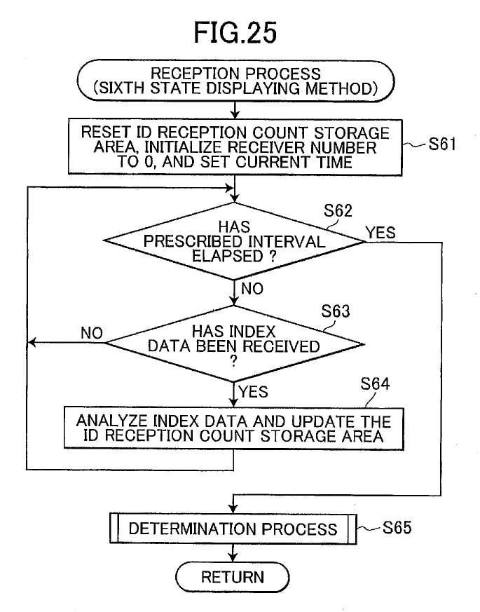

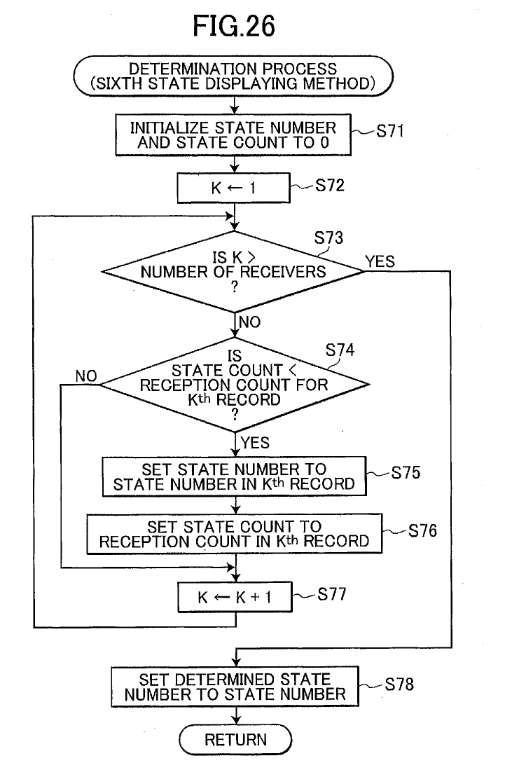

FIG. 23 is an explanatory diagram conceptually illustrating a configuration of storage areas in a RAM 530 used in the sixth state displaying method. FIG. 24 is a table illustrating a structure of an ID reception count storage area 534 provided in the ROM 20 for the sixth state displaying method. FIG. 25 is a flowchart illustrating steps in the reception process of the sixth state displaying method. FIG. 26 is a flowchart illustrating steps in the determination process performed during the reception process of the sixth state displaying method.

First, variables used in the reception process and the outputting process will be described with reference to FIG. 23. The RAM 530 is provided with a current time storage area 531, a state counter K storage area 532, a determined state number storage area 533, an ID reception count storage area 534, a state number storage area 535, a state count storage area 536, a receiver number storage area 537, and the like.

The current time storage area 531 and state counter K storage area 532 have the same function as the current time storage area 136 and state counter K storage area 131 in FIG. 6 for the first state displaying method. The determined state number storage area 533 stores the state number of a state indicated by the index data last received from a status communication device 1 that transmitted the most index data in the prescribed interval. The ID reception count storage area 534 (see FIG. 24) stores the count of index data received during the prescribed interval (10 seconds, for example) for each corresponding state, an ID for the status communication device 1 that transmitted the index data, and the state number of the state indicated by the index data. The state number storage area 535 stores the state number indicating the most recent state of the status communication device 1 that transmitted the most index data at the time the CPU 10 checks the status communication device 1 that transmitted the most index data during the prescribed interval in the determination process. The state count storage area 536 stores the count for the ID having the highest count at the time the CPU 10 checks the reception count for each state in the determination process. The receiver number storage area 537 stores the number of other status communication devices (the number of different IDs) that received index data in the reception process.

Next, the ID reception count storage area 534 will be described with reference to FIG. 24. The ID reception count storage area 534 is configured of a source ID column, a count column, and a state number column. When index data is received from a status communication device 1 whose ID is not recorded in the ID reception count storage area 534, the ID of the status communication device 1 is recorded in the source ID column of the ID reception count storage area 534, 1 is stored in the respective count column, and the index data (state number) is stored in the respective state number column. If index data is received from a status communication device 1 whose ID is already recorded in the ID reception count storage area 534, the value in the count column associated with the same ID in the source ID column is incremented by 1, and the index data (state number) is stored in the corresponding state number column.

In the example of FIG. 24, the count 2 and the state no. 2 are stored in association with the source ID 1000 in a first record, the count 3 and the state no. 2 are stored in association with the source ID 1003 in a second record, and the count 1 and the state no. 3 are stored in association with the source ID 1002 in a third record.

As in the first state displaying method, the sixth state displaying method involves the main reception process, reception process, determination process, main outputting process, and other data outputting process. Since the main reception process, main outputting process, and other data outputting process in the sixth state displaying method are identical to those in the first state displaying method (see FIGS. 8, 11, and 12), only the reception process and determination process will be described with reference to FIGS. 25 and 26.

In S61 at the beginning of the process in FIG. 25, the CPU 10 resets the ID reception count storage area 534 so that the ID reception count storage area 534 contains no records, initializes the receiver number storage area 537 to 0, acquires the current time from the timer 40 for measuring the prescribed interval (10 seconds, for example), and stores the current time in the current time storage area 531 of the RAM 530.

In S62 the CPU 10 determines whether the prescribed interval has elapsed. Specifically, the CPU 10 acquires the current time from the timer 40 and the time stored in the current time storage area 531, calculates the elapsed time based on their difference, and determines whether the elapsed time is greater than or equal to the prescribed interval (10 seconds, for example). If the prescribed interval has not elapsed (S62: NO), then in S63 the CPU 10 determines whether index data has been received from another status communication device 1. If no index data has been received (S63: NO), the CPU 10 returns to S62. However, if index data has been received (S63: YES), then in S64 the CPU 10 analyzes the received index data and updates the ID reception count storage area 534. More specifically, since this received index data is the first index data, the CPU 10 creates a first record, records the source ID in the index data in the source ID column, stores 1 in the count column, and stores the index data (state number) in the state number column. Subsequently, the CPU 10 returns to S62. Each time a new record is created in S64 the CPU 10 increments the value in the receiver number storage area 537 by 1.

If the prescribed interval has elapsed after repeating the process in S62-S64 (S62: YES), then in S65 the CPU 10 performs the determination process (see FIG. 26) and subsequently returns to the main reception process. Further, if the CPU 10 determines in S63 that index data was received (S63: YES), but the source ID included in the received index data has not been recorded in the source ID column, the CPU 10 appends a new record to the records stored in the ID reception count storage area 534, stores the ID of the received index data in the source ID column, stores 1 in the count column, and stores the index data (state number) in the state number column. When index data has been received (S63: YES) and the source ID included in the index data has already been recorded in the source ID column of the ID reception count storage area 534, then the CPU 10 increments the value in the count column by 1 and stores the index data (state number) in the state number column of the record holding the same ID in the source ID column.

Next, the determination process will be described with reference to FIG. 26. The determination process is performed for index data received by all status communication devices (receivers) 1. In S71 of the determination process, the CPU 10 stores an initial value of 0 in each of the state number storage area 535 and state count storage area 536. In S72 the CPU 10 initializes the state counter K in the state counter K storage area 532 to 1.

In S73 the CPU 10 determines whether the value of the state counter K is greater than the number of receivers in order to determine whether all states have been checked. If the state counter K is not greater than the number of receivers (S73: NO), then in S74 the CPU 10 reads the state count for the K^{th} record in the ID reception count storage area 534 and compares this count to the value stored in the state count storage area 536. If the state count read from the ID reception count storage area 534 is larger (S74: YES), then in S75 the CPU 10 reads the state number for the K^{th} record from the ID reception count storage area 534 and stores this state number in the state number storage area 535 and in S76 stores the count read in S74 in the state count storage area 536. Since the first record in the example of FIG. 24 has the count 2 and the state no. 2 and the state count storage area 536 has been initialized to 0 at this time, the CPU 10 stores 2 in the state number storage area 535 and 2 in the state count storage area 536. In S77 the CPU 10 increments the state counter K by 1, so that the state counter K is now 2, and returns to S73.

Since the value of the state counter K (2) is not greater than the number of receivers (3) (S73: NO), the CPU 10 reads the count for state no. 2 from the ID reception count storage area 534 (3 in this example) and stores 2 in the state count storage area 536. Hence, the count read above is greater than the value stored in the state count storage area 536 (S74: YES), and the CPU 10 stores a 2 in the state number storage area 535 in S75 and stores a 3 in the state count storage area 536 in S76. In S77 the CPU 10 increments the state counter K by 1, so that the state counter K is now 3, and returns to S73.

Since the value of the state counter K is not greater than the number of receivers (3) (S73: NO), the CPU 10 reads the count for state no. 3 from the ID reception count storage area 534 and stores 3 in the state count storage area 536. The CPU 10 determines that the count read above is not greater than the value stored in the state count storage area 536 (S74: NO), and advances to S77 to increment the state counter K by 1, so that the state counter K is now 4. Subsequently, the CPU 10 returns to S73. Since the value of the state counter K (4) is greater than the number of receivers (3) (S73: YES), in S78 the CPU 10 stores the state number from the state number storage area 535 in the determined state number storage area 533. Subsequently, the CPU 10 returns to the reception process in FIG. 25 and then returns to the main reception process in FIG. 8. Based on the example shown in FIG. 24, the CPU 10 has stored 2 in the determined state number storage area 533.

Hence, in the other data outputting process of FIG. 12 performed during the main outputting process of FIG. 11, the CPU 10 lights the LEDs 217-222 having the color corresponding to the state number determined in the above process. Accordingly, in the sixth state displaying method, the status communication device 1 can indicate with the LEDs 217-222 the state of the other status communication device 1 that transmitted the most index data.

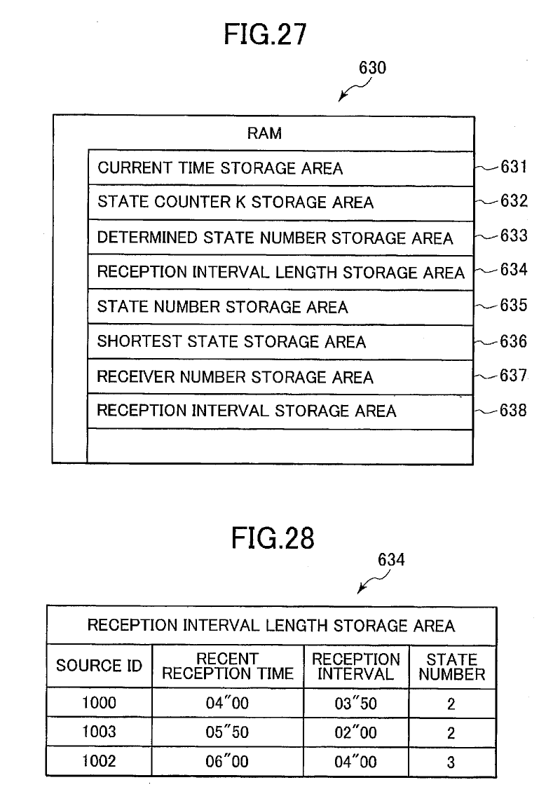

Next, the seventh state displaying method performed on the status communication device 1 will be described with reference to FIGS. 27 through 33. In the seventh state displaying method, the status communication device 1 uses the LEDs 217-222 to indicate the state corresponding to the last index data received from the status communication device 1 that transmitted index data within the shortest interval.

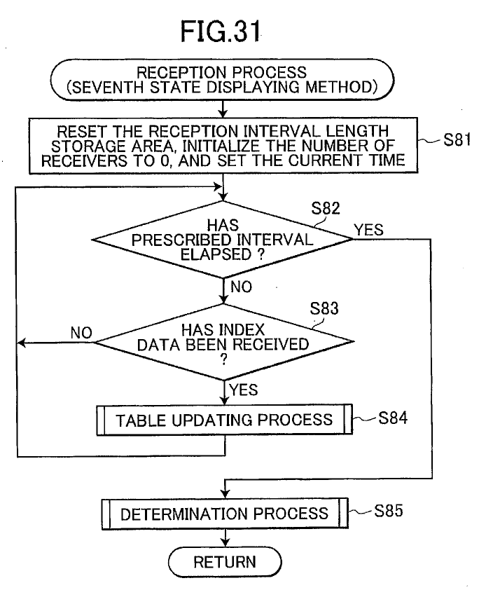

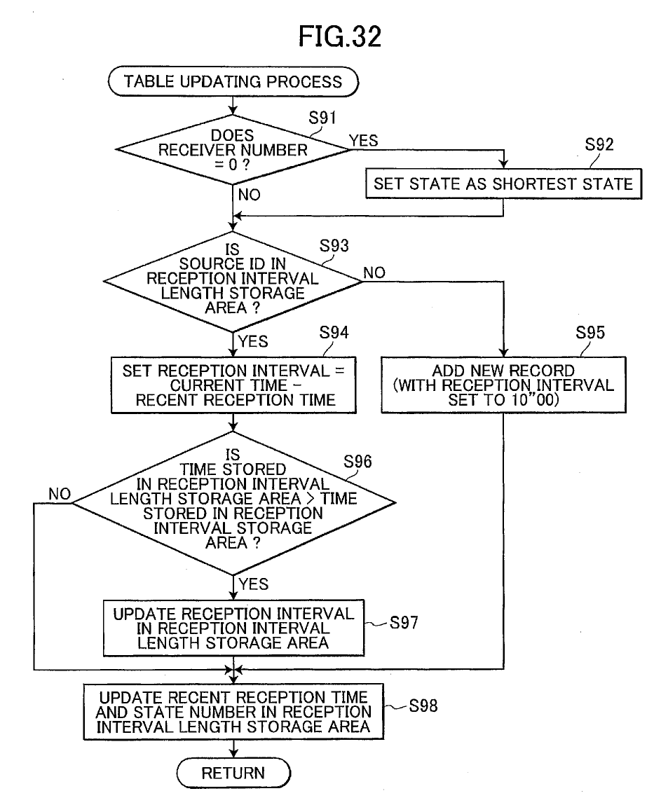

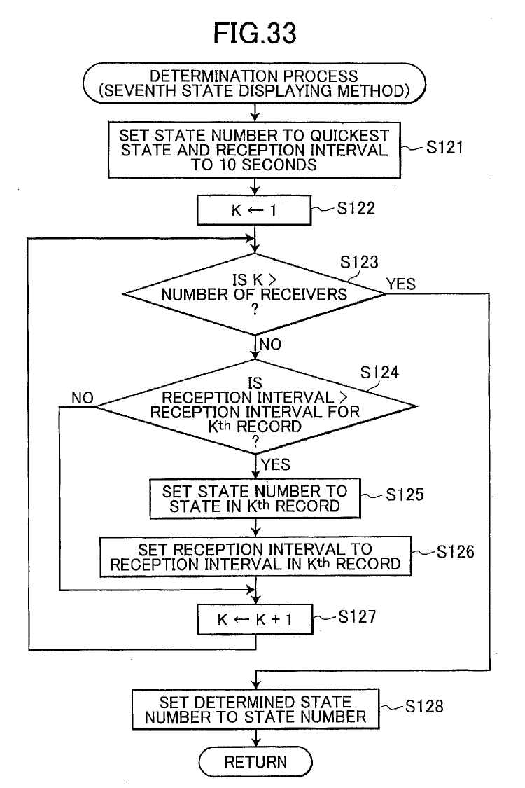

FIG. 27 is an explanatory diagram conceptually illustrating the configuration of storage areas in a RAM 630 used in the seventh state displaying method. FIGS. 28, 29, and 30 are tables conceptually illustrating the structure of a reception interval length storage area 634 provided in the RAM 630. FIG. 31 is a flowchart illustrating steps in a reception process of the seventh state displaying method. FIG. 32 is a flowchart illustrating steps in a table updating process performed during the reception process. FIG. 33 is a flowchart illustrating steps in the determination process performed during the reception process.

First, variables used in the reception process and the outputting process will be described with reference to FIG. 27. The RAM 630 is provided with a current time storage area 631, a state counter K storage area 632, a determined state number storage area 633, a reception interval length storage area 634, a state number storage area 635, a shortest state storage area 636, a receiver number storage area 637, a reception interval storage area 638, and the like.

The current time storage area 631 and state counter K storage area 632 have the same functions as the current time storage area 136 and state counter K storage area 131 in FIG. 6 according to the first state displaying method. The determined state number storage area 633 stores the state number of a state indicated by the last index data received from another status communication device 1 that transmitted index data within the shortest interval. The reception interval length storage area 634 stores IDs for status communication devices 1 that transmitted index data within the prescribed interval (10 seconds, for example), the time at which the last index data was received from the status communication devices 1 corresponding to the IDs, the time of the shortest interval in which index data was received from the status communication devices 1 corresponding to the IDs, and the state number indicated by the index data (see FIGS. 28-30). The state number storage area 635 stores the state number for the most recent state of the status communication device 1 indicated by the index data transmitted in the shortest interval at the time the CPU 10 checks the status communication device 1 transmitting index data in the shortest interval during the determination M process. The shortest state storage area 636 stores the state number for the ID having the shortest reception interval at the time the reception count for each state was checked in the determination process. The receiver number storage area 637 stores the number of other status communication devices 1 (the number of IDs) from which index data was received in the reception process. The reception interval storage area 638 temporarily stores a calculated reception interval for comparison purposes.

Next, the reception interval length storage area 634 will be described with reference to FIGS. 28 through 30. As shown in FIGS. 28 through 30, the reception interval length storage area 634 is configured of a source ID column, a recent reception time column, a reception interval column, and a state number column. When index data is received from a status communication device 1 whose ID is not recorded in the reception interval length storage area 634, the ID with the index data is recorded in the source ID column of the reception interval length storage area 634, the elapsed time from the beginning of measuring the prescribed interval is stored in the recent reception time column, the value 10″00 is stored in the reception interval column, and the index data (state number) is stored in the state number column. When index data is received from a status communication device 1 whose ID is already recorded in the reception interval length storage area 634, the elapsed time since beginning of measuring the prescribed interval is stored in the recent reception time column of the record containing the same ID in the source ID column, the difference between the time stored in the recent reception time column and the elapsed time is stored in the reception interval column corresponding to the same ID, and the index data (state number) is stored in the corresponding state number column.

In the example of FIG. 28, index data has been received from three status communication devices 1 with the source IDs 1000, 1003, and 1002. The recent reception time and reception interval for the source ID 1000 are 4″00 and 3″50, respectively, while the state indicated by the last index data is state no. 2. The recent reception time and reception interval for source ID 1003 are 5″50 and 2″00, respectively, while the state indicated by the last index data is state no. 2. The recent reception time and reception interval for source ID 1002 are 6″00 and 4″00, respectively, while the state indicated by the last index data is state no. 3.

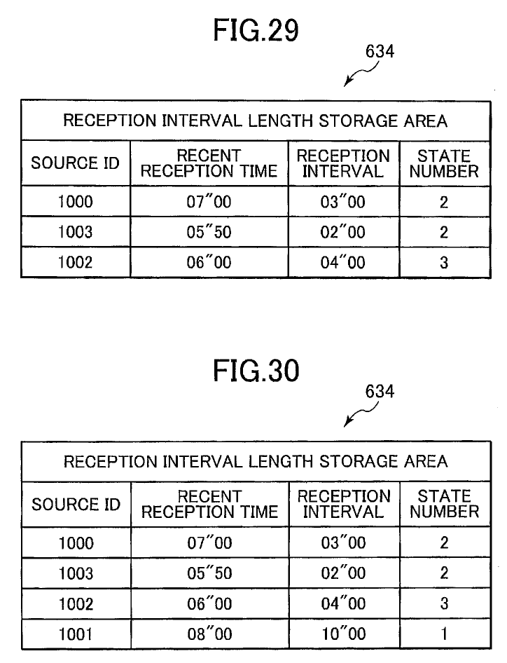

FIG. 29 shows the state of the reception interval length storage area 634 updated from the state shown in FIG. 28 immediately after index data indicating state no. 2 was received from the status communication device 1 having the source ID 1000. Hence, the recent reception time for the source ID 1000 has changed from 4″00 to 7″00, and the reception interval has been changed to 3″00 by taking the difference between 7″00 and 4″00.

FIG. 30 shows the state of the reception interval length storage area 634 updated from the state shown in FIG. 29 immediately after index data indicating state no. 1 was received from the status communication device 1 having a source ID 1001. Hence, a new record with the source ID 1001 has been appended to the table stored in the reception interval length storage area 634, and the values 8″00, 10″00, and 1 have been stored in the corresponding recent reception time, reception interval, and state number columns, respectively.

As in the first state displaying method, the seventh state displaying method involves the main reception process, reception process, determination process, main outputting process, and other data outputting process. Since the main reception process, main outputting process, and other data outputting process in the seventh state displaying method are identical to those in the first state displaying method (see FIGS. 8, 11, and 12), only the reception process and the determination process will be described with reference to FIGS. 31 through 33. In S81 of FIG. 31, the CPU 10 resets the reception interval length storage area 634 so that the reception interval length storage area 634 holds no records, stores an initial value of 0 in the receiver number storage area 637, acquires the current time from the timer 40 for measuring the prescribed interval (10 seconds, for example), and stores this current time in the current time storage area 631 of the RAM 630 to begin measuring the prescribed interval.

In S82 the CPU 10 determines whether the prescribed interval has elapsed. Specifically, the CPU 10 acquires the current time from the timer 40 and the time stored in the current time storage area 631, measures the elapsed time based on the difference of these times, and determines whether the elapsed time is greater than or equal to the prescribed interval (10 seconds in this example). If the prescribed interval has not elapsed (S82: NO), in S83 the CPU 10 determines whether index data was received from another status communication device 1. If no index data was received (S83: NO), the CPU 10 returns to S82. However, if index data was received (S83: YES), then in S84 the CPU 10 analyzes the received index data and performs a table updating process (see FIG. 32) to update the reception interval length storage area 634. More specifically, the CPU 10 creates a first record, since the index data is the first received at this time, stores the source ID included in the index data in the source ID column of this record, stores the elapsed time since the measurement of the prescribed interval began in the recent reception time column, stores 10″00 in the reception interval column, stores the index data (state number) in the state number column, and returns to S82.

When the prescribed interval has elapsed after repeating the process in S82-S84 (S82: YES), in S85 the CPU 10 executes the determination process (see FIG. 33) and subsequently returns to the main reception process.

In S91 of the table updating process shown in FIG. 32, the CPU 10 determines whether the index data is the first received, based on whether the value in the receiver number storage area 637 is the initial value of 0. If the receiver number storage area 637 stores 0 (S91: YES), then in S92 the CPU 10 stores the received index data (state number) in the shortest state storage area 636. In S93 the CPU 10 determines whether the ID indicated by the received index data has been stored in the source ID column of the reception interval length storage area 634. Since the reception interval length storage area 634 contains no records when the CPU 10 receives the first index data, the ID is not stored in the source ID column (S93: NO). Therefore, in S95 the CPU 10 adds a new record to the reception interval length storage area 634 and stores 10″00 in the reception interval column. In S98 the CPU 10 acquires the current time from the timer 40 and the time stored in the current time storage area 631, calculates the difference of these times, stores the difference in the recent reception time column, and stores the index data (state number) in the state number column. Subsequently, the CPU 10 returns the reception process. Further, when creating a new record in S95, the CPU 10 increments the value in the receiver number storage area 637 by 1.

If the index data is not the first index data received, then the number of receivers is 1 rather than 0 (S91: NO). Accordingly, since there is no need to store the state number in the shortest state storage area 636, the CPU 10 skips to S93 to determine whether the ID of the received index data is stored in the source ID column of the reception interval length storage area 634. If the received index data has already been received from the status communication device 1 with this ID, the ID has already been stored in the source ID column of the reception interval length storage area 634 (S93: YES). Therefore, in S94 the CPU 10 stores the elapsed time since the preceding reception in the reception interval storage area 638. Specifically, the CPU 10 acquires the current time from the timer 40 and the time stored in the current time storage area 631, calculates the difference of these times as the current reception time, and calculates the difference between this current reception time and the time stored in the recent reception time column of the reception interval length storage area 634.

In S96 the CPU 10 compares the time calculated in S94 and stored in the reception interval storage area 638 with the time stored in the reception interval column of the reception interval length storage area 634 to determine which is shorter. If the time stored in the reception interval storage area 638 is shorter (S96: YES), then in S97 the CPU 10 stores this time in the reception interval column of the reception interval length storage area 634. In S98 the CPU 10 acquires the current time from the timer 40 and the time stored in the current time storage area 631, calculates the difference of these times, stores this difference in the recent reception time column, and stores the index data (state number) in the state number column. However, if the time stored in the reception interval storage area 638 is not shorter (S96: NO), then the CPU 10 skips to S98 without updating the value in the reception interval column of the reception interval length storage area 634. Subsequently, the CPU 10 returns to the reception process in FIG. 31.

Next, the determination process will be described with reference to the flowchart in FIG. 33. In S121 of the determination process in FIG. 33, the CPU 10 stores the state number from the shortest state storage area 636 in the state number storage area 635 as the initial value and stores 10 seconds in the reception interval storage area 638 as an initial value. In S122 the CPU 10 sets the state counter K in the state counter K storage area 532 to the initial value of 1.

In S123 the CPU 10 determines whether the value of the state counter K is greater than the number of receivers (4 in the example of FIG. 30) in order to determine whether all states have been checked. If the state counter K is not greater than the number of receivers (S123: NO), in S124 the CPU 10 reads the reception interval from the K^{th} record in the reception interval length storage area 634 and compares this interval to the value stored in the reception interval storage area 638. If the reception interval stored in the reception interval length storage area 634 is shorter (S124: YES), then in S125 the CPU 10 stores the state number in the state number column of the K^{th} record in the reception interval length storage area 634 in the state number storage area 635 and in S126 stores the value recorded in the K^{th} reception interval column of the reception interval length storage area 634 in the reception interval storage area 638. Since the reception interval 3″00 is recorded in the reception interval length storage area 634 for the first ID 1000 in the example of FIG. 30, and 3″00 is shorter than 10″00 stored in the reception interval storage area 638, the CPU 10 stores state no. 2 in the state number storage area 635 and 3″00 in the reception interval storage area 638. In S127 the CPU 10 increments the state counter K by 1, so that the state counter K is now 2, and returns to S123.

Since the value of the state counter K (2) is not greater than the number of receivers (S123: NO), and the reception interval time 2″00 for the second ID is shorter than the reception interval 3″00 stored in the reception interval storage area 638 (S124: YES), the CPU 10 stores state no. 2 for the second record in the state number storage area 635 and 2″00 in the reception interval storage area 638. In S127 the CPU 10 increments the state counter K by 1, so that the state counter K is now 3, and returns to S123.

When the value of the state counter K becomes 5 after repeating the process in S123-S127, so that the state counter K becomes greater than the number of receivers (S123: YES), then in S128 the CPU 10 stores the value from the reception interval storage area 638 in the determined state number storage area 633. Subsequently, the CPU 10 returns to the reception process in FIG. 31 and then to the main reception process in FIG. 8. With the example shown in FIG. 30, “2” is now stored in the determined state number storage area 633.

In the subsequent other data outputting process of FIG. 12 performed during the main outputting process of FIG. 11, the CPU 10 lights the LEDs 217-222 having the color corresponding to the state number determined above. Hence, in the seventh state displaying method, the status communication device 1 can indicate the state corresponding to the last index data from the status communication device 1 that transmitted index data in the shortest interval using the LEDs 217-222.

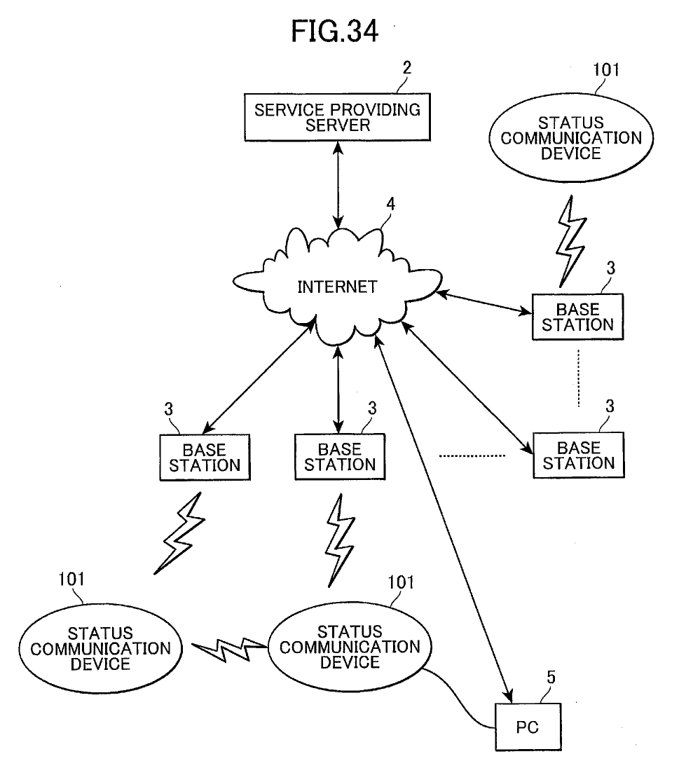

Next, a status communication device 101 according to a second embodiment of the present invention will be described. First, an overall structure of a service providing system employing the status communication devices 101 of the second embodiment will be described. FIG. 34 is an explanatory diagram illustrating the structure of such a service providing system employing the status communication devices 101.

As shown in FIG. 34, the service providing system employing the status communication devices 101 includes a service providing server 2 that can connect to an internet 4. Each of the status communication devices 101 can connect to a base station 3 for a mobile communication network, such as a cell phone network or a PHS telephone network, and connect to the internet 4 via the base station 3. Each status communication device 101 can also communicate with another status communication device 101 when in close proximity thereto. The status communication devices 101 may also connect to a personal computer (hereinafter abbreviated as “PC”) 5 by a cable and can acquire data from the PC 5 or transmit data to the PC 5. The PC 5 can also connect to the internet 4.

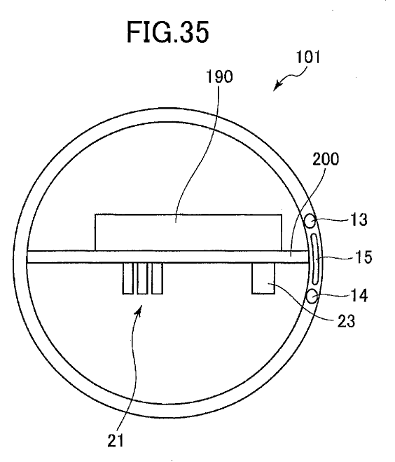

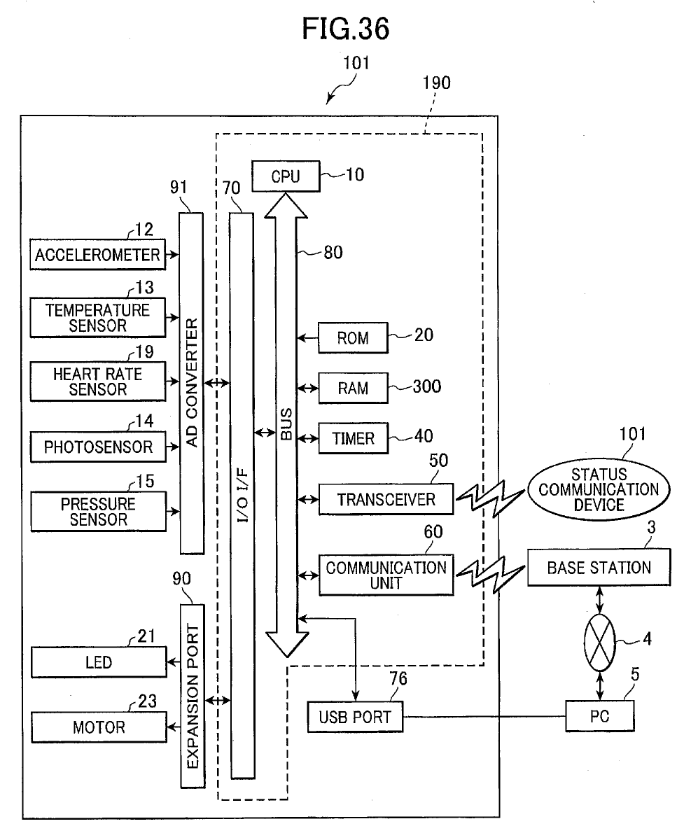

Next, the status communication device 101 according to the second embodiment will be described in greater detail. Further, an emotions/environment inferring process according to the second embodiment will be described. This process corresponds to the emotions/environment inferring process performed by the status communication device 1 according to the first embodiment (S103 in FIG. 11). Components of the status communication device 101 having the same structure as those of the status communication device 1 in the first embodiment have been designated with the same reference numerals to avoid duplicating description. FIG. 35 is an explanatory diagram showing the structure of the status communication device 101, and FIG. 36 is a block diagram showing the electrical structure of the status communication device 101.

As shown in FIG. 35, the status communication device 101 has a spherical shape and is of a size capable of fitting in the palm of a person's hand. The casing of the status communication device 101 is formed of a transparent synthetic resin in a spherical shape and has a thickness of several millimeters (5 mm, for example). The interior of the status communication device 101 is a spherically shaped airtight space. A disc-shaped substrate 200 is provided inside the casing. Various sensors 12-15 and 19 (see FIG. 36), various actuators 21 and 23, a controller 190, and the like are disposed on or connected to the substrate 200.

For purposes of description, only the temperature sensor 13, photosensor 14, and pressure sensor 15 of the sensors 12-15 and 19 are shown in FIG. 35. Further, the actuators include the LEDs 21 and motor 23. In the preferred embodiment, the temperature sensor 13, photosensor 14, and pressure sensor 15 are disposed near the point of intersection with the peripheral surface of the casing and a plane passing through the center of the status communication device 101. Further, the LEDs 21 and the motor 23 are disposed on the bottom side of the substrate 200 in FIG. 35, while the controller 190 is disposed on the top.

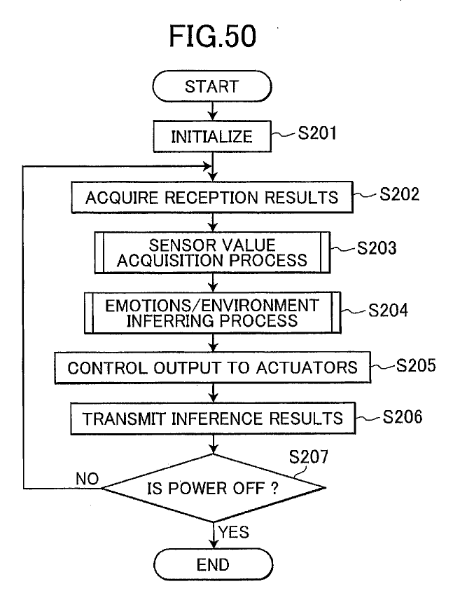

As shown in FIG. 36, the internal structure of the status communication device 101 is basically the same as the status communication device 1 according to the first embodiment shown in FIG. 4. The ROM 20 stores a status communication program for implementing the main process described later in FIG. 50. A RAM 300 of the status communication device 101 is provided with a storage area for storing data detected (measured) by the sensors 12-15 and 19 (a measurement value storage area).

A USB port 76 is also provided on the surface of the status communication device 101 for connecting to the PC 5. The USB port 76 is also connected to the bus 80. Hence, the PC 5 can be connected to the status communication device 101 by connecting the PC 5 to the USB port 76 with a USB cable. The status communication device 101 further includes an AD converter 91 connected to each of the sensors 12-15 and 19, and an expansion port 90 for inserting the actuators 21 and 23. The AD converter 91 is connected to the CPU 10 via the I/O interface 70 and bus 80. Analog measurement data outputted from the sensors 12-15 and 19 is converted to digital data by the AD converter 91 and inputted into the controller 190. The expansion port 90 is also connected to the CPU 10 via the I/O interface 70 and bus 80. Digital instruction signals outputted from the controller 190 are inputted into the actuators 21 and 23 via the expansion port 90. The sensors 12-15 and 19 are detachably mounted on the AD converter 91 and can be added, replaced, and the like. The actuators 21 and 23 are detachably mounted on the expansion port 90 and can be added, replaced, and the like.

Next, the temperature sensor 13 and the heart rate sensor 19 of the second embodiment will be described. The temperature sensor 13 measures the ambient temperature around the status communication device 101, as well as the temperature of the user's fingers or palm touching the device. The heart rate sensor 19 is configured of an infrared sensor for detecting displacement between the expansion and contraction of blood flow for measuring the heart rate (pulse rate) of the user touching the device.

The status communication device 101 is not provided with a keyboard such as that used with a personal computer. Data detected by the sensors 12-15 and 19 of the status communication device 101 is prerecorded as command input for instructing the execution of prescribed operations. For example, if the user grips the status communication device 101 or gestures by waving or gripping the device a prescribed number of times, for example, the status communication device 101 is instructed to perform a prescribed operation.

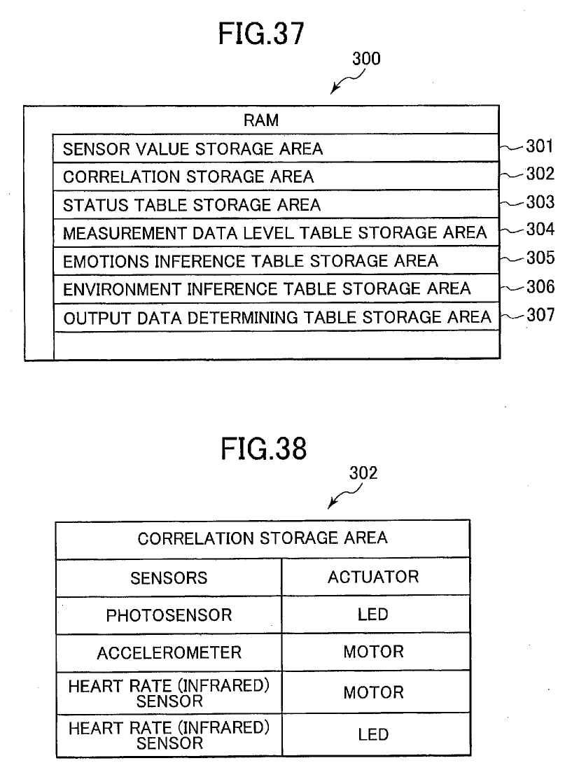

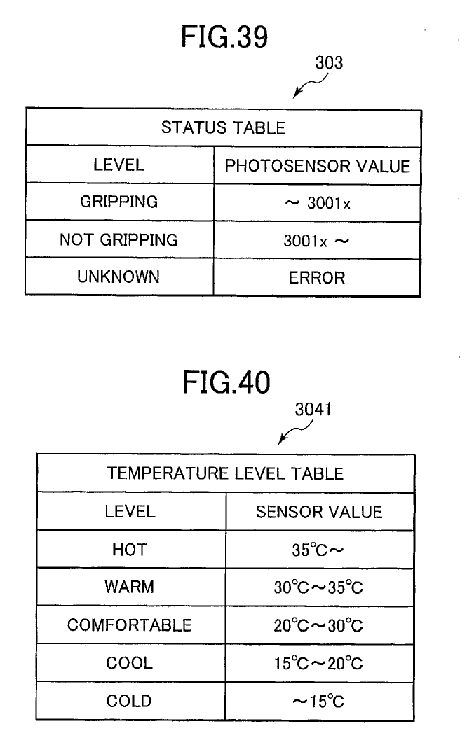

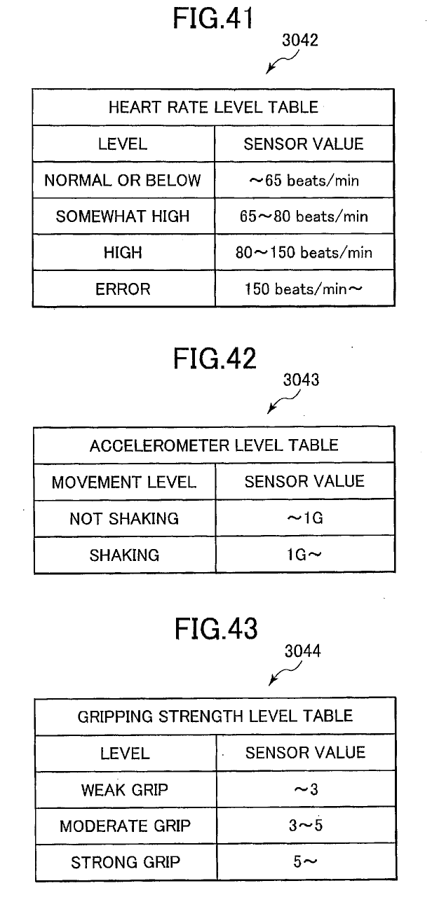

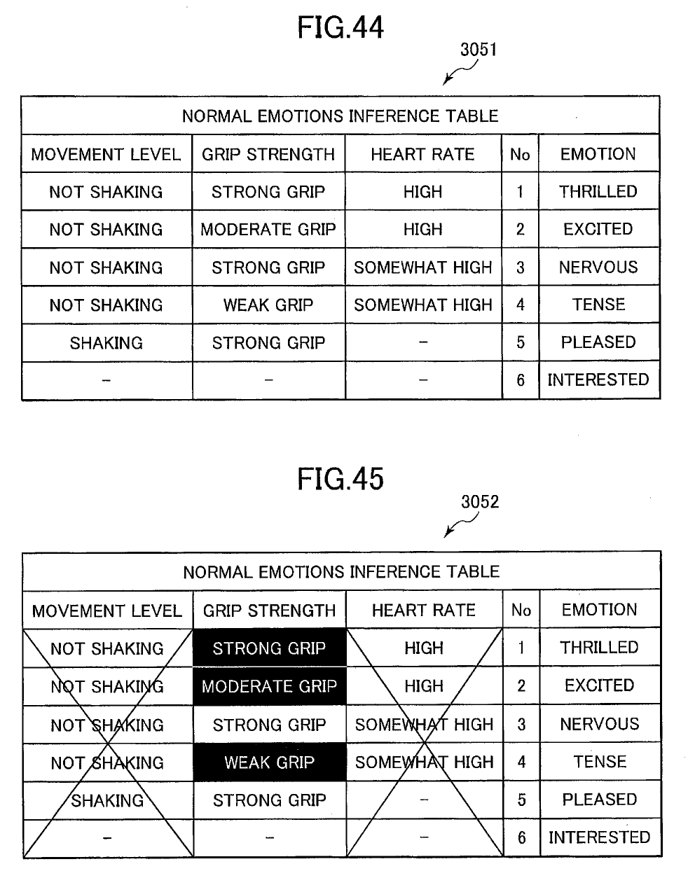

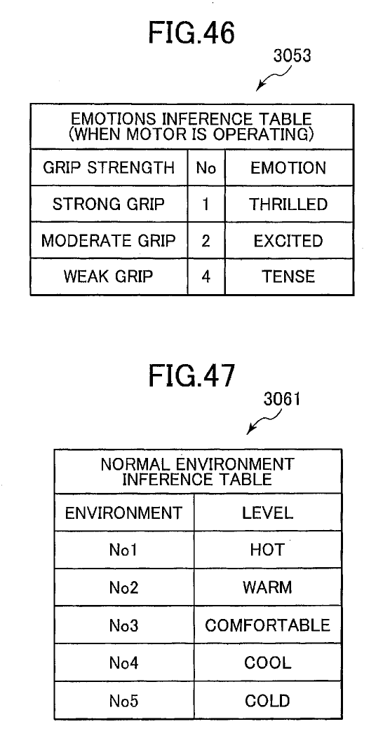

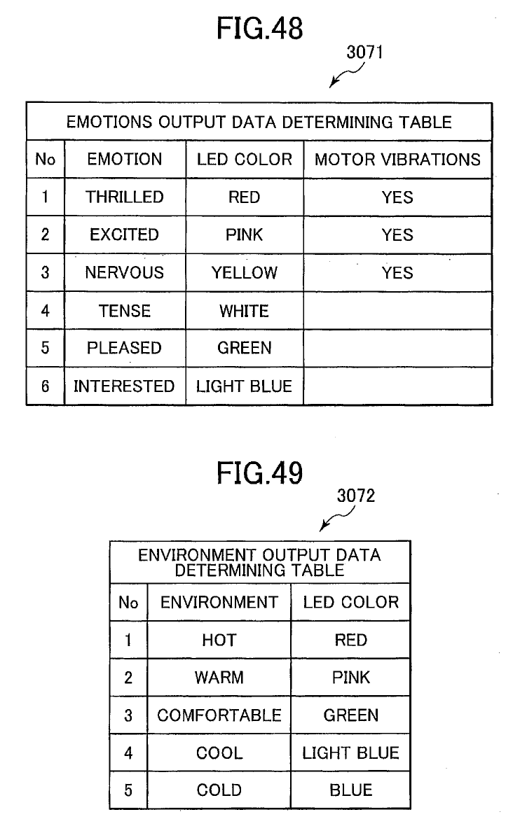

Next, storage areas in the RAM 300 of the status communication device 101 storing tables and the like will be described with reference to FIGS. 37 through 49. FIG. 37 is an explanatory diagram conceptually illustrating a configuration of the storage areas in the RAM 300. FIG. 38 is a table conceptually illustrating a structure of a correlation storage area 302 of the RAM 300. FIG. 39 is an explanatory diagram conceptually illustrating a status table stored in a status table storage area 303. FIG. 40 is an explanatory diagram conceptually illustrating a structure of a temperature level table 3041 stored in a measurement data level table storage area 304 of the RAM 300. FIG. 41 is an explanatory diagram conceptually illustrating a structure of a heart rate level table 3042 stored in the measurement data level table storage area 304 of the RAM 300. FIG. 42 is an explanatory diagram conceptually illustrating a structure of an accelerator level table 3043 stored in the measurement data level table storage area 304 of the RAM 300. FIG. 43 is an explanatory diagram conceptually illustrating the structure of a gripping strength level table 3044 stored in the measurement data level table storage area 304 of the RAM 300. FIG. 44 is an explanatory diagram conceptually illustrating a normal emotions inference table 3051 stored in an emotions inference table storage area 305 of the RAM 300. FIG. 45 is an explanatory diagram conceptually illustrating another example of a normal emotions inference table 3052 stored in the emotions inference table storage area 305 and used when including error in the measurement data. FIG. 46 is an explanatory diagram conceptually illustrating an example of an emotions inference table 3053 for use during motor activity. FIG. 47 is an explanatory diagram conceptually illustrating a structure of a normal environment inference table 3061 stored in an environment inference table storage area 306. FIG. 48 is an explanatory diagram conceptually illustrating a structure of an emotions output data determining table 3071 stored in an output data determining table storage area 307. FIG. 49 is an explanatory diagram conceptually illustrating a structure of an environment output data determining table 3072 stored in the output data determining table storage area 307.

As shown in FIG. 37, the RAM 300 is provided with a sensor value storage area 301, a correlation storage area 302, a status table storage area 303, the measurement data level table storage area 304, the emotions inference table storage area 305, the environment inference table storage area 306, the output data determining table storage area 307, and other storage areas not shown in FIG. 37. The sensor value storage area 301 stores values measured by the sensors 12-15 and 19. The correlation storage area 302 stores correlations between actuators and sensors whose measurement values could be influenced by operations of the actuators. The status table storage area 303 stores a status level table for determining as a status level whether the status communication device 101 is gripped. The measurement data level table storage area 304 stores various measurement data level tables for determining the current status level based on measurement values (measurement data) outputted from the sensors 12-15 and 19 (sensor values). The emotions inference table storage area 305 stores an emotions inference table for inferring the emotions of a user based on the measurement data. The environment inference table storage area 306 stores an environment inference table for inferring the environmental conditions based on the measurement data. The output data determining table storage area 307 stores output data determining tables for setting output data to be outputted to the actuators based on the emotions inference data and the environment inference data.

The sensor value storage area 301 stores several values (five values, for example) outputted from each of the sensors, including the accelerometer 12, temperature sensor 13, photosensor 14, pressure sensor 15, and heart rate sensor 19, and converted to digital data by the expansion port 90.

The correlation storage area 302 stores correlations between sensors and the actuators that might affect measurements measured by the sensors. In the example of FIG. 38, the correlation storage area 302 stores correlations indicating that output from the LEDs 21 affects the photosensor 14, output from the motor 23 affects the accelerometer 12, and output from both the motor 23 and the LEDs 21 affects the infrared heart rate sensor 19. Correlations between sensors and actuators are not limited to the example of FIG. 38, since there are many types of sensors and actuators, and may be more suitably handled in a database. The status communication device 101 may also be provided with the flashlamp 22, heater 24, speaker 25, and microphone 29 described for the status communication device 1 according to the first embodiment.

As shown in FIG. 39, the status table storage area 303 stores a status table for determining whether the user is currently holding the status communication device 101 or not based on an output value from the photosensor 14. The user is found to be holding the status communication device 101 when the measured value from the photosensor 14 is less than 300 lx and not holding the status communication device 101 when the measured value is equal to or greater than 300 lx. The status is unknown if an error occurred in the measured value outputted from the photosensor 14.

As shown in FIGS. 40 through 43, the measurement data level table storage area 304 stores various tables for setting levels based on measurement data (measurement values) from various sensors. Specifically, the measurement data level table storage area 304 stores a temperature level table 3041 for setting a temperature level based on output from the temperature sensor 13, a heart rate level table 3042 for setting a heart rate level based on output from the heart rate sensor 19, an accelerator level table 3043 for setting a gesture level based on output from the accelerometer 12, a gripping strength level table 3044 for setting a strength level at which the status communication device 101 is gripped based on output from the pressure sensor 15, and measurement data level tables (not shown) for determining levels based on other sensor values.

As shown in FIG. 40, the temperature level table 3041 functions to set ambient temperatures to five levels ranging from “hot” to “cold” based on output from the temperature sensor 13. Specifically, with the temperature level table 3041 shown in FIG. 40, the temperature level is set to “hot” when the sensor output exceeds 35° C., “warm” when the sensor output is between 30 and 35° C., “comfortable” when the sensor output is between 20 and 30° C., “cool” when the sensor output is between 15 and 20° C., and “cold” when the sensor output is below 15° C.

As shown in FIG. 41, the heart rate level table 3042 functions to set one of four heart rate levels based on output from the heart rate sensor 19, which level is used as an index for inferring the emotional state of the user. In the heart rate level table 3042 shown in FIG. 41, the heart rate level is set to “normal or below” when the sensor output is 65 beats/minute, “somewhat high” when the sensor output is between 65 and 80 beats/minute, “high” when the sensor output is between 80 and 150 beats/minute, and “error” when the sensor output exceeds 150 beats/minute, which is considered an abnormal value.

As shown in FIG. 42, the accelerator level table 3043 functions to set a level for gestures performed by the user based on output from the accelerometer 12. Specifically, the example of the accelerator level table 3043 shown in FIG. 42 determines that the user is “not gripping” the status communication device 101 when the sensor output is less than or equal to 1 G, and is “gripping” the status communication device 101 when the sensor output exceeds 1 G.

As shown in FIG. 43, the gripping strength level table 3044 functions to set a level of gestures performed by the user based on output from the pressure sensor 15. Specifically, the gripping strength level table 3044 in FIG. 43 determines that the user has a “weak grip” on the status communication device 101 when the sensor value is less than 3, a “moderate grip” on the status communication device 101 when the sensor value is between 3 and 5, and a “strong grip” on the status communication device 101 when the sensor value exceeds 5.

The level tables based on sensors described above are merely examples. Other tables may also be stored for setting index data based on sensor values to be used in an inference process.

The emotions inference table storage area 305 (see FIG. 37) stores an emotions inference table for inferring the emotions of a user using the status communication device 101 by combining the various measurement data levels determined according to the measurement data level tables described above. In the preferred embodiment, two emotions inference tables are used according to the method of acquiring measurement data and the method of inferring emotions.

As shown in FIG. 44, the normal emotions inference table 3051 functions to infer emotions of the user through a combination of a movement level determined by the accelerator level table 3043, the grip strength level determined by the gripping strength level table 3044, and the heart rate level determined by the heart rate level table 3042. Based on the example of the normal emotions inference table 3051 in FIG. 44, the status communication device 1 infers the user's emotions to be “thrilled” (inference no. 1) when the movement level is “not shaking,” the grip strength level is “strong grip,” and the heart rate is “high”; “excited” (inference no. 2) when the movement level is “not shaking,” the grip strength level is “moderate grip,” and the heart rate is “high”; “nervous” (inference no. 3) when the movement level is “not shaking,” the grip strength level is “strong grip,” and the heart rate is “somewhat high”; “tense” (inference no. 4) when the movement level is “not shaking,” the grip strength level is “weak grip,” and the heart rate is “somewhat high”; “pleased” (inference no. 5) when the movement level is “shaking,” and the grip strength level is “strong grip,” regardless of the heart rate; and “interested” (inference no. 6) for all other combinations of measurement data levels.

In order to infer the emotions of the user using the normal emotions inference table 3051, it is essential that the measurement data from the sensors be obtained properly. If a value from any sensor could not be obtained, an error value is stored in the sensor value storage area 301, indicating that the normal emotions inference table 3051 cannot be used. In such a case, emotions of the user are inferred based solely on measurement data levels determined according to properly measured sensor values. For example, if measurement data levels cannot be determined from sensor values obtained from the accelerometer 12 and heart rate sensor 19, due to error values when the motor 23 is operating, only the grip strength level is used for inferring the emotions of the user, as shown in the normal emotions inference table 3052 in FIG. 45. In this way, appropriate emotional inference can be performed when sensor values contain errors due to the operation of the actuators 21 and 23.

Other emotions inference tables using part of the normal emotions inference table 3051 may be separately prepared to handle error values generated by operations of the actuators 21 and 23. For example, the emotions inference table 3053 shown in FIG. 46 may be prepared for cases in which the motor 23 is operating. The emotions inference table 3053 functions to infer the emotions of the user based solely on the grip strength level when the motor is operating. According to the example shown in FIG. 46, the status communication device 1 infers the emotions of the user to be “thrilled” (inference no. 1) when the grip strength level is “strong grip”; “excited” (inference no. 2) when the grip strength level is “moderate grip”; and “tense” (inference no. 4) when the grip strength level is “weak grip.”

The environment inference table storage area 306 (see FIG. 37) stores an environment inference table for inferring the ambient state around the status communication device 101 when the status table storage area 303 indicates that the status communication device 101 is not “gripped” by the user. As shown in FIG. 47, the normal environment inference table 3061 functions to set an inference number for the results of environment inference based on a level set in the temperature level table 3041. Specifically, the normal environment inference table 3061 sets the environmental state to inference no. 1 when the temperature level is “hot,” inference no. 2 when the temperature level is “warm,” inference no. 3 when the temperature level is “comfortable,” inference no. 4 when the temperature level is “cool,” and inference no. 5 when the temperature level is “cold.”

The output data determining table storage area 307 (see FIG. 37) stores the emotions output data determining table 3071 and environment output data determining table 3072 shown in FIGS. 48 and 49. As will be described later, the emotions of the user and the environment of the status communication device 101 are inferred based on output (measurement data) from the sensors 12-15 and 19, and values (inference numbers) are outputted to actuators, such as the LEDs 21 and motor 23, based on the results of this inference. The emotions output data determining table 3071 and environment output data determining table 3072 function to set these output values.

For example, the status communication device 101 outputs inference results (output data) based on the emotions output data determining table 3071 shown in FIG. 48 when inferring the emotions of the user. Specifically, the status communication device 101 outputs inference results for lighting the red LED 21 and vibrating the motor for inference no. 1, lighting the pink LED 21 and vibrating the motor for inference no. 2, lighting the yellow LED 21 and vibrating the motor for inference no. 3, lighting the white LED 21 without vibrating the motor for inference no. 4, lighting the green LED 21 without vibrating the motor for inference no. 5, and lighting the light blue LED 21 without vibrating the motor for inference no. 6. While the emotions output data determining table 3071 described above includes output data (inference result) only for the LEDs 21 and motor 23, the table may also be used to determine output data for other actuators in the same way.

The status communication device 101 outputs inference results according to the environment output data determining table 3072 shown in FIG. 49 when inferring the environment. Specifically, the status communication device 101 outputs inference results for turning on the red LED 21 for inference no. 1, the pink LED 21 for inference no. 2, the green LED 21 for inference no. 3, the light blue LED 21 for inference no. 4, and the blue LED 21 for inference no. 5.

Next, the operations of the status communication device 101 will be described. FIG. 50 is a flowchart illustrating steps in the main process. Power is supplied to the status communication device 101 by a battery provided therein. When the power to the status communication device 101 is turned on, the CPU 10 executes a status communication program continuously for implementing the main process in FIG. 50.

In S1 of FIG. 50 the CPU 10 initializes various data, flags, and the like. For example, the CPU 10 initializes the sensor value storage area 301 storing output values from the sensors 12-15 and 19 and clears a counter for counting the number of gestures.

After the initialization in S201, the sensors 12-15 and 19 begin performing measurements, and the sensors 12-15 and 19 perform measurements continuously during the main process. Sensor values are stored in the sensor value storage area 301 of the RAM 300 at prescribed intervals (every 5 seconds, for example). Hence, the sensor values stored in the sensor value storage area 301 are updated at this prescribed interval. If another status communication device 101 exists within the range of radio waves, while the status communication device 101 executes the main process, and the other status communication device 101 transmits data, the CPU 10 of the status communication device 101 performs an interrupt process to temporarily store the contents of such data in the RAM 300. In S202 the CPU 10 acquires received data from a reception data storage area (not shown) in the RAM 300.

In S203 the CPU 10 executes a sensor value acquisition process for acquiring sensor values outputted from the sensors 12-15 and 19 from the sensor value storage area 301. In S204 the CPU 10 executes the emotions/environment inferring process for calculating index values (index data, state number) based on the acquired sensor values (equivalent to S103 in FIG. 11 of the first embodiment). The sensor value acquisition process and emotions/environment inferring process will be described later.

Next, the CPU 10 determines output data by referencing the emotions output data determining table 3071 (see FIG. 48) or the environment output data determining table 3072 (see FIG. 49) stored in the output data determining table storage area 307 based on inference results obtained in S204 and reception data acquired from another status communication device 101 in S202. The CPU 10 references the emotions output data determining table 3071 when the emotions inferring process is executed in S204 and references the environment output data determining table 3072 when the environment inferring process is executed in S204. In S205 the CPU 10 controls output from the LEDs 21 and motor 23 based on the output data determined above. Since the LEDs 21 can emit light in a desired direction, the CPU 10 controls the LEDs 21 to output light downward for the inference results of the status communication device 101 itself and to output light upward for the inference results received from another status communication device 101. When outputting inference results from another status communication device 101, the CPU 10 selects one state using one of the first through seventh state displaying methods described in the first embodiment, and indicates this state with the LEDs 21.

In S206 the CPU 10 transmits the results of emotion inference or environment inference calculated in S204 to the other status communication device 101. In S207 the CPU 10 determines whether the power has been turned off. The CPU 10 ends the main process if the power is off (S207: YES), and repeats the process from S202 if the power has not been turned off (S207: NO).

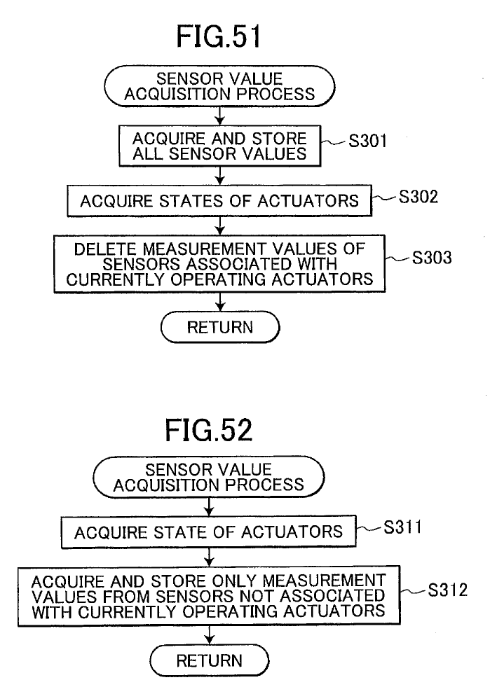

Next, the sensor value acquisition process executed during the main process will be described in detail with reference to FIG. 51. FIG. 51 is a flowchart illustrating steps in this process. In S301 at the beginning of the sensor value acquisition process, the CPU 10 acquires measurement values outputted from all sensors 12-15 and 19 and stores the values in the sensor value storage area 301 of the RAM 300.

In S302 the CPU 10 acquires the states of the actuators 21 and 23 (indicating whether the actuators are operating (outputting) or not). In S303 the CPU 10 references the correlation storage area 302 in the RAM 300 and deletes measurement values from the sensor value storage area 301 for any sensor associated in the correlation storage area 302 with currently operating actuators. Subsequently, the CPU 10 returns to the main process. In this way, if there is potential for operating actuators to influence measurement values, the CPU 10 can remove this influence.

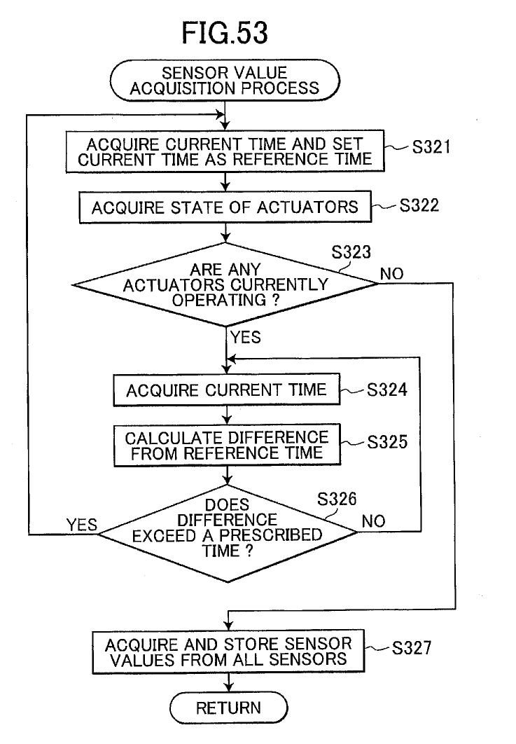

The sensor value acquisition process may be performed according to methods other than that described above with reference to FIG. 51. Next, other examples of the sensor value acquisition process will be described with reference to FIGS. 52 and 53. FIGS. 52 and 53 are flowcharts showing variations of the sensor value acquisition process.

In S311 at the beginning of the sensor value acquisition process shown in FIG. 52, the CPU 10 acquires the actuation state of the actuators 21 and 23. In S312 the CPU 10 references the correlation storage area 302 in the RAM 300 to select sensors not associated with currently operating actuators, and acquires and stores only measurement values from the selected sensors in the sensor value storage area 301 of the RAM 300. Subsequently, the CPU 10 returns to the main process. In this way, the CPU 10 checks the actuation state of the actuators prior to acquiring the sensor values.

In S321 of the sensor value acquisition process shown in FIG. 53, the CPU 10 acquires the current time from the timer 40 and sets this time as a reference time. In S322 the CPU 10 acquires the actuation states of the actuators 21 and 23. In S323 the CPU 10 determines whether any actuators are currently operating based on the acquisition results in S322. If no actuators are currently operating (S323: NO), then in S327 the CPU 10 acquires measurement values from all sensors 12-15 and 19 and stores these values in the sensor value storage area 301 of the RAM 300. Subsequently, the CPU 10 returns to the main process.

However, if one or more actuators are current operating (S323: YES), then in S324 the CPU 10 acquires the current time from the timer 40 and in S325 calculates the difference between the current time and the reference time acquired in S321. In S326 the CPU 10 determines whether the difference calculated in S325 exceeds a prescribed time. If this difference does not exceed the prescribed time (S326: NO), then the CPU 10 returns to S324 and again acquires the current time from the timer 40. When the difference found in S325 exceeds the prescribed time (S326: YES), the CPU 10 returns to S321 and sets the reference time to the current time. While repeating the process described above, the CPU 10 does not acquire measurement values from the sensors 12-15 and 19 if one of the actuators 21 and 23 is operating, thereby not acquiring sensor values affected by the actuators.

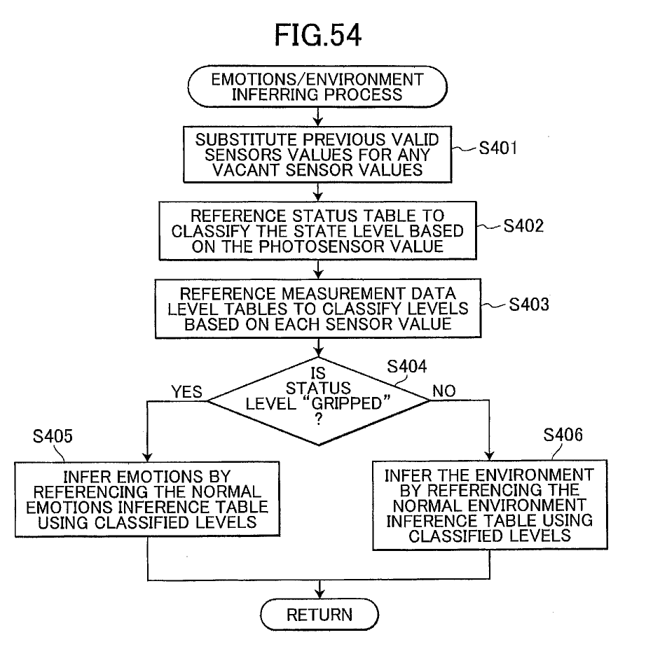

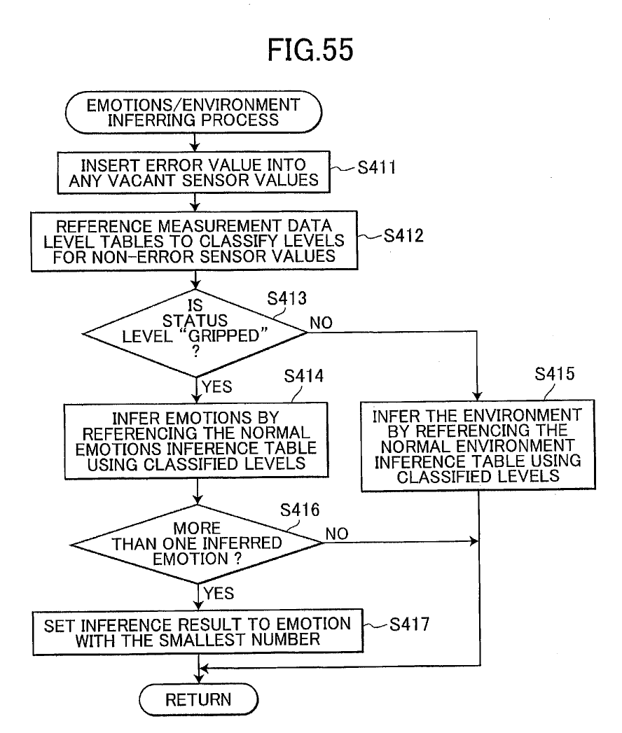

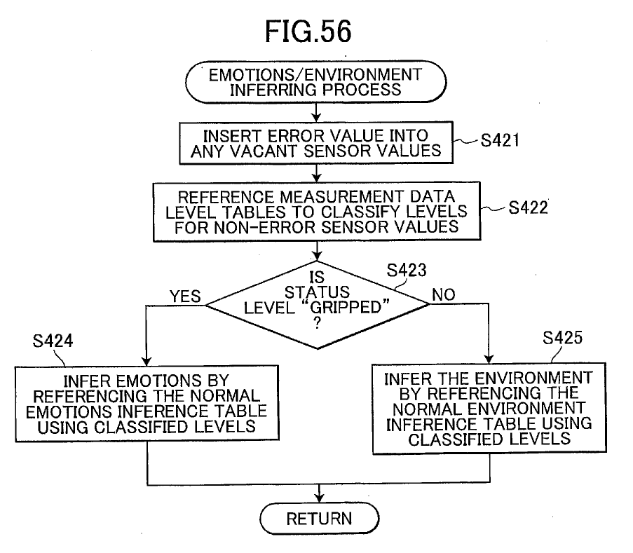

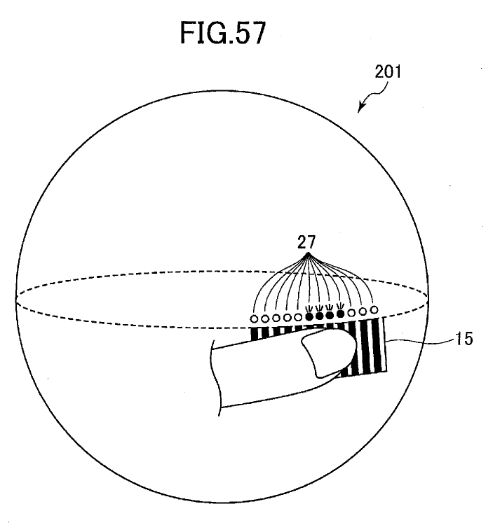

Next, the emotions/environment inferring process executed during the main process will be described with reference to FIGS. 54 through 56. FIG. 54 is a flowchart illustrating steps in the emotions/environment inferring process. FIG. 55 is a flowchart illustrating steps in a variation of the emotions/environment inferring process. FIG. 56 is a flowchart illustrating steps in another variation of the emotions/environment inferring process.

In S401 at the beginning of the emotions/environment inferring process shown in FIG. 54, the CPU 10 checks for any vacant sensor values in the sensor value storage area 301 due to such values being discarded in the sensor value acquisition process, and substitutes previous valid sensor values into these vacancies. If no vacant sensor values exist, then the CPU 10 takes no action in this step.

In S402 the CPU 10 acquires measurement data for the photosensor 14 from the sensor value storage area 301 and references the status table stored in the status table storage area 303 (see FIG. 39) to determine whether the status level, indicating whether the status communication device 101 is gripped, is “gripped,” “not gripped,” “unknown.”

In S403 the CPU 10 acquires sensor values for all sensors other than the photosensor 14 from the sensor value storage area 301, and determines each measurement data level by referencing measurement level data tables corresponding to each sensor value stored in the measurement data level table storage area 304, such as the heart rate level table 3042 (see FIG. 41) corresponding to the heart rate sensor 19, the accelerator level table 3043 (see FIG. 42) corresponding to the accelerometer 12, and the gripping strength level table 3044 (see FIG. 43) corresponding to the pressure sensor 15.

In S404 the CPU 10 determines whether the status level determined in S402 is “gripped.” If the status level is “gripped” (S404: YES), indicating that the user is currently holding the status communication device 101, then in S405 the CPU 10 performs the emotions inferring process by referencing the normal emotions inference table 3051 (see FIG. 44) stored in the emotions inference table storage area 305 using the measurement data levels determined in S403. Subsequently, the CPU 10 returns to the main process.

However, if the status level is “not gripped” (S404: NO), indicating that the user is not currently holding the status communication device 101, then in S406 the CPU 10 executes the environment inferring process by referencing the normal environment inference table 3061 (see FIG. 47) stored in the environment inference table storage area 306 based on the temperature level determined in S403. Subsequently, the CPU 10 returns to the main process.

Since the emotions/environment inferring process always use the normal emotions inference table and the normal environment inference table and make inferences based on the previous sensor value in the above method, variations of the acquired inference results are similar to the inference results of when the actuators 21 and 23 does not operate. Accordingly, the status communication device 1 can perform appropriate output.

Further, while the process in FIG. 54 inserts previous sensor values for vacant sensor values, the CPU 10 may instead insert an error value for vacant values. In such a case, the CPU 10 may use only relevant values in the normal emotions inference table 3051 or may employ special emotions inference tables for each case in which error values have been inserted. The former example is described next with reference to FIG. 55, the latter example will be described with reference to FIG. 56.

In S411 at the beginning of the emotions/environment inferring process shown in FIG. 5, the CPU 10 checks for vacant sensor values in the sensor value storage area 301 resulting when the sensor values were discarded in the sensor value acquisition process and inserts an error value into these vacancies. If there are no missing sensor values, the CPU 10 performs no processing in this step.

In S412 the CPU 10 extracts sensor values for the sensors 12-15 and 19 from the sensor value storage area 301 and determines measurement data levels for each sensor value by referencing the measurement data level table stored in the measurement data level table storage area 304, such as the heart rate level table 3042 (see FIG. 41) corresponding to the heart rate sensor 19, the accelerator level table 3043 (see FIG. 42) corresponding to the accelerometer 12, and the gripping strength level table 3044 (see FIG. 43) corresponding to the pressure sensor 15. In S412 the CPU 10 also determines the status value corresponding to the photosensor 14 by referencing the status table stored in the status table storage area 303 (see FIG. 39) based on the sensor value for the photosensor 14 stored in the sensor value storage area 301.

In S413 the CPU 10 determines whether the status level found in S412 is “gripped.” If the status level is “gripped” (S413: YES), indicating that the user is currently holding the status communication device 101, then in S414 the CPU 10 performs the emotions inferring process by referencing the normal emotions inference table 3052 stored in the emotions inference table storage area 305 based on the measurement levels determined in S412. In this case, the normal emotions inference table 3052 shown in FIG. 45 is referenced, wherein levels that cannot be determined due to the insertion of error values have been removed.

In S416 the CPU 10 determines whether there is more than one inferred emotion. Ordinarily, there is not a plurality of inference results because inference is performed based on a plurality of combinations of measurement data levels. However, when the only valid measurement data level is the grip strength level, as shown in FIG. 45, a plurality of inference results can be produced since there are three inference numbers corresponding to the result “strong grip” (inference numbers 1, 3, and 5). If there is a plurality of results (S416: YES), then in S417 the CPU 10 sets the inference result to the smallest inference number. When there exists only one inference results (S416: NO), the CPU 10 simply returns to the main process.

However, if the status level is not “gripped” (S413: NO), i.e. “not gripped” or “unknown,” then in S415 the CPU 10 executes the environment inferring process by referencing the normal environment inference table 3061 stored in the environment inference table storage area 306 (see FIG. 47) based on the temperature level determined in S412. Subsequently, the CPU 10 returns the main process.

In this way, the CPU 10 can infer either the user's emotion or the environment without using all sensor values when some sensor values have been discarded due to operating actuators 21 and 23. Further, it is not necessary to prepare a plurality of emotions/environment inference tables.

The variation shown in FIG. 56 may also be executed when vacant sensor values exist. In S421 at the beginning of this emotions/environment inferring process, the CPU 10 substitutes an error value for vacant sensor values produced because sensor values were discarded in the sensor value acquisition process.

In S422 the CPU 10 extracts valid sensor values (i.e., non-error values) for the sensors 12-15 and 19 from the sensor value storage area 301 and sets measurement data levels by referencing measurement data level tables corresponding to each sensor value that are stored in the measurement data level table storage area 304, such as the heart rate level table 3042 (see FIG. 41) corresponding to the heart rate sensor 19, the accelerator level table 3043 (see FIG. 42) corresponding to the accelerometer 12, and the gripping strength level table 3044 (see FIG. 43) corresponding to the pressure sensor 15. In S422 the CPU 10 also determine the status level corresponding to the photosensor 14 by referencing the status table stored in the status table storage area 303 (see FIG. 39) based on the sensor value from the photosensor 14 stored in the sensor value storage area 301.

In S423 the CPU 10 determines whether the status level found in S422 is “gripped.” If the status level is “gripped” (S423: YES), indicating that the user is currently holding the status communication device 101, then in S424 the CPU 10 performs the emotions inferring process by referencing a special emotions inference table stored in the emotions inference table storage area 305 using the measurement data levels determined in S422. For example, the CPU 10 may infer emotions by referencing the emotions inference table 3053, as shown in FIG. 46, when the motor is operating. Subsequently, the CPU 10 returns to the main process.

If the status level is not “gripped” (S423: NO), i.e. “not gripped” or “unknown,” then in S425 the CPU 10 executes the environment inferring process by referencing the normal environment inference table stored in the environment inference table storage area 306 (see FIG. 47) based on the temperature level determined in S422. Subsequently, the CPU 10 returns to the main process.

In this way, the CPU 10 can infer the emotions or environment without using all sensor values when some sensor values were discarded due to operation of an actuator. Further, by preparing special inference tables, it is possible to more closely handle cases in which measurement data could not be obtained from the sensors.

With the status communication device 101 according to the second embodiment described above, measurements by the sensors 12-15 and 19 are controlled by discarding measurement data from sensors that could be affected by output from the actuators 21 and 23 or by simply not acquiring measurement data when an actuator is operating, and by executing the emotions inferring process or environment inferring process based on the controlled sensor values, thereby outputting more appropriate inference results. The status communication device 101 according to the second embodiment also obtains similar effects to those described in the first embodiment.

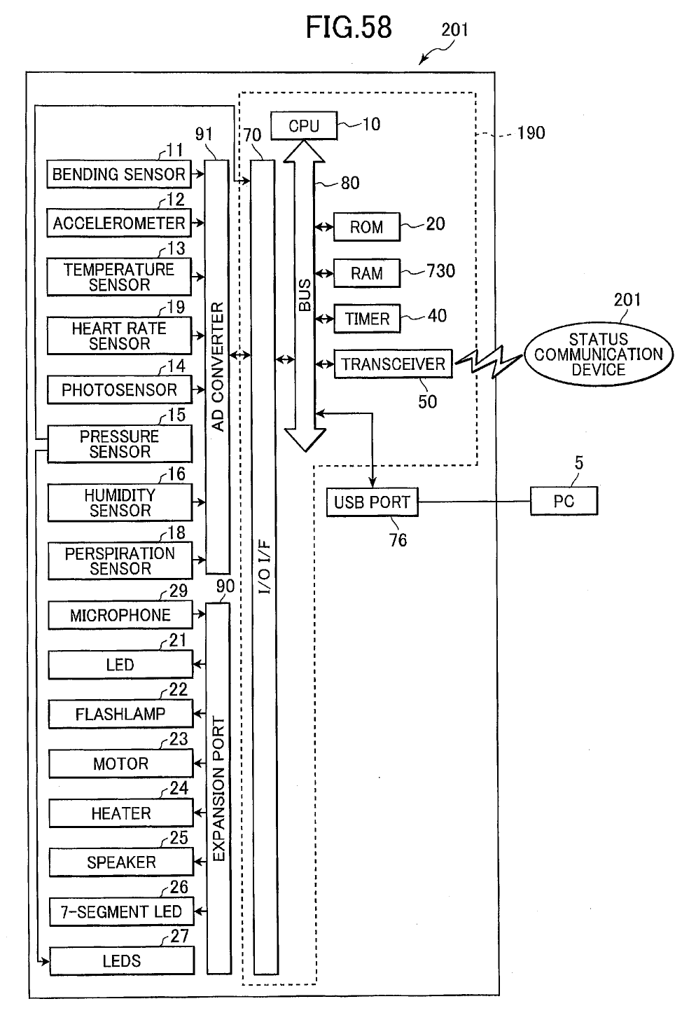

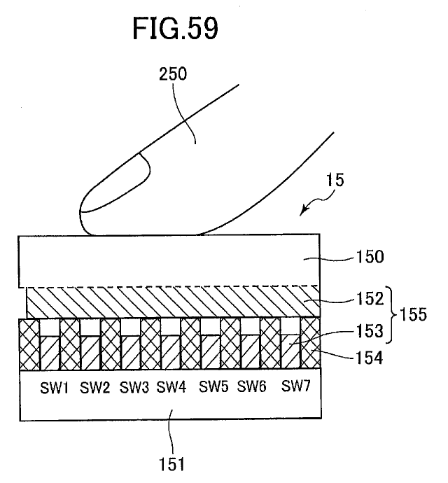

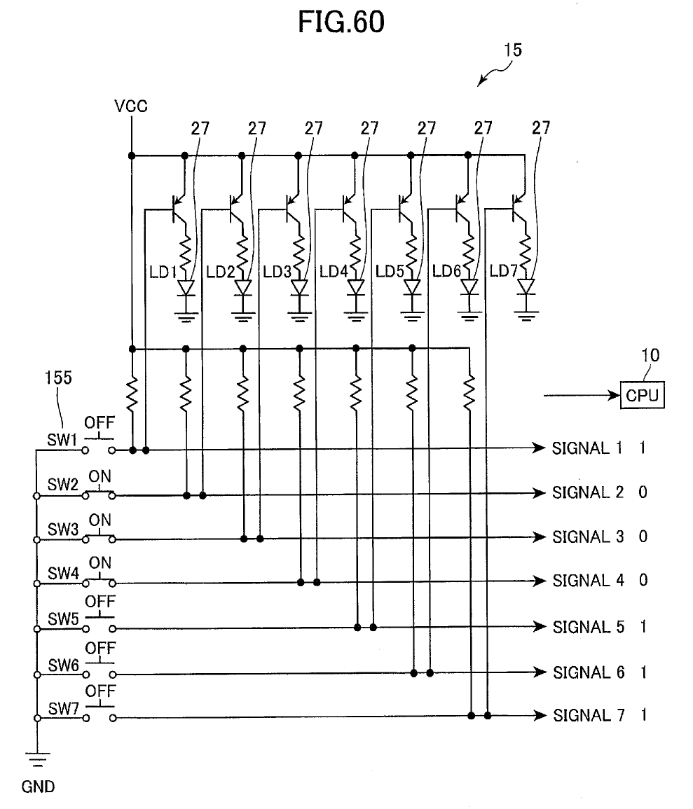

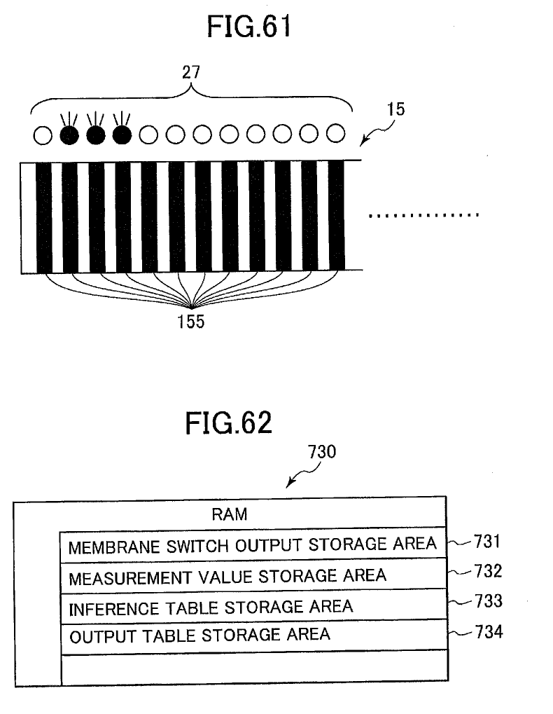

Next, a status communication device 201 according to a third embodiment of the present invention will be described with reference to the drawings. The status communication device 201 has a similar structure to the status communication devices 1 and 101 of the first and second embodiments, with like parts and components are designated with the same reference numerals to avoid duplicating description. First, a structure of the status communication device 201 according to the third embodiment and a pressure sensor 15 provided on the surface of the status communication device 201 will be described. FIG. 57 is an explanatory diagram of the status communication device 201. FIG. 58 is a block diagram showing an electrical structure of the status communication device 201. FIG. 59 is a cross-sectional view of the pressure sensor 15. FIG. 60 is a drive circuit diagram showing the pressure sensor 15 configured of membrane switches SW and showing an LED for indicating when the membrane switches conduct electricity. FIG. 61 is an explanatory diagram showing the correspondence between the pressure sensor 15 and LEDs 27 for sensor display.

As shown in FIG. 57, the status communication device 201 is a spherical body similar to the status communication device 101 according to the second embodiment of a size for fitting in the palm of one's hand. The casing of the status communication device 201 is formed of a transparent synthetic resin in an elliptical shape and has a thickness of several millimeters (5 mm, for example). An airtight spherical space is defined in the interior of the casing. A disc-shaped substrate (not shown) is provided inside the casing. Various sensors 11-16, 18, 19, and 29; various actuators 21-26, a controller 190, and the like are mounted on or connected to the substrate (see FIG. 58).

In order to simplify the description, only the pressure sensor 15 from among the sensors 11-16, 18, 19, and 29 is shown in FIG. 57. The strip-like pressure sensor 15 is provided in a position near the intersection of a plane passing through the center of the status communication device 201 and the peripheral surface of the casing, which is a position where the user's thumb is likely to touch when the user grips the status communication device 201. Further, the LEDs 27 for displaying the status of the pressure sensor 15 are provided on the top of the pressure sensor 15 in FIG. 57.

As shown in FIG. 58, the internal structure of the status communication device 201 is basically the same as the status communication devices 1 and 101 according to the first and second embodiments shown in FIGS. 4 and 36.

The ROM 20 stores an inference data creating program for executing an inference data creation process described later (see FIG. 72). A RAM 730 of the status communication device 201 includes various storage areas described later, including an area for storing data detected (measured) by the sensors 11-16, 18, 19, and 29. In addition to this structure, the status communication device 201 may be provided with a communication unit for communicating with base stations on a wireless network in order to receive services through the network. Further, one of the actuators is a 7-segment LED 26 for displaying each of the single-digit numbers.

The status communication device 201 is not provided with a keyboard such as that used with a personal computer. Therefore, data (measurement values) detected by the sensors 11-16, 18, 19, and 29 of the status communication device 201 is prerecorded as input for indicating prescribed operations. Hence, the user can command the status communication device 201 to perform an operation through gestures involving gripping the status communication device 201 (e.g., gripping or shaking the status communication device 201 a prescribed number of times).

Next, the pressure sensor 15 will be described with reference to FIGS. 59 through 61. As shown in FIG. 59, the pressure sensor 15 includes a top substrate 150 bonded to contact points 152 formed of carbon and silver, and a bottom substrate 151 bonded to contact points 153 formed of carbon. The pressure sensor 15 also includes flexible insulating spacers 154 interposed between and bonded to the top substrate 150 and bottom substrate 151 to form a membrane sheet. The insulating spacers 154 are provided alternately with the contact points 153 on the bottom substrate 151. Individual membrane switches 155 are configured of the contact points 152 and contact points 153 sandwiched by the insulating spacers 154. The membrane switches 155 have a width of about 1.6 mm and are arranged at substantially equal intervals (configuring switches SW1-SW7 in the drawing).

Both the top substrate 150 and the bottom substrate 151 are formed of polyethylene terephthalate (PET), which is an insulating material. When a finger 250, the insulating spacers 154 in the pressed region compress, allowing the contact points 152 to contact the contact points 153 so that electricity is conducted therethrough.

When contact points 152 and contact points 153 contact each other and conduct electricity, the membrane switches 155 turn on. At this time, an electric current flows from a power supply V_{cc} to a ground GND, as shown in FIG. 60, producing an output voltage of 0 V, so that “0” is inputted into the CPU 10. When the contact points 152 separate from the contact points 153, the membrane switches 155 turns off, and the output voltage returns to V_{cc} so that “1” is inputted into the CPU 10. In the example of FIG. 60, the switch SW1 is off so that “1” is outputted as signal 1, switch SW2 is on so that “0” is outputted as signal 2, switch SW3 is on so that “0” is outputted as signal 3, switch SW4 is on so that “0” is outputted as signal 4, switch SW5 is off so that “1” is outputted as signal 5, switch SW6 is off so that “1” is outputted as signal 6, and switch SW7 is off so that “1” is outputted as signal 7. Every 0.01 seconds, the CPU 10 stores an input signal from each membrane switch 155 in a membrane switch output storage area 731 (see FIG. 62) of the RAM 730 and counts the number of ON signals (0 values) at that point. In addition to the contact switches described above, the membrane switches may be configured of capacitive coupling switches that conduct electricity when the contacts are in proximity to each other.

As shown in FIGS. 61 and 57, the LEDs 27 are provided directly above and in proximity to the pressure sensor 15 at positions corresponding to the membrane switches 155. As shown in FIG. 60, when the membrane switches 155 conduct electricity and output an ON value, a PNP-type transistor turns on, supplying electricity for turning on a corresponding LED 27. Since the SW2-SW4 are on in the example of FIG. 60, the corresponding LDs (LEDs) 2-4 are lit. Therefore, the user can immediately and visually recognize which of the membrane switches 155 are turned on by the user's finger.

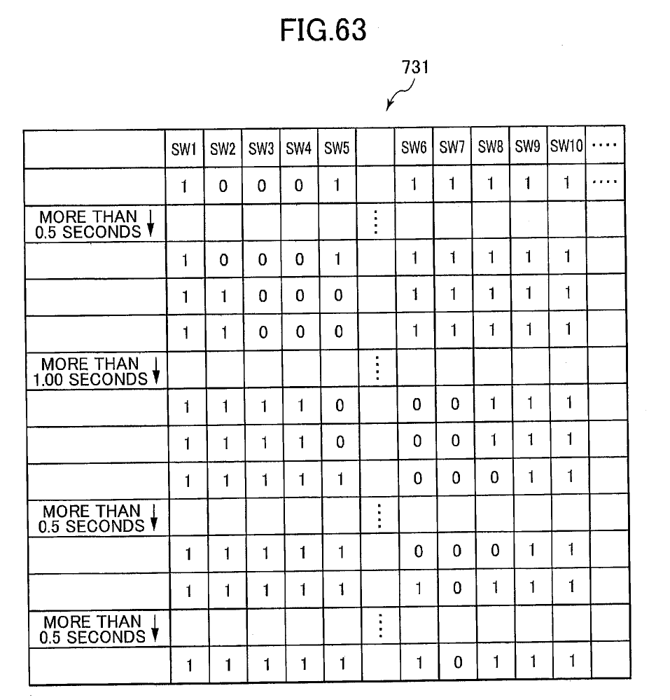

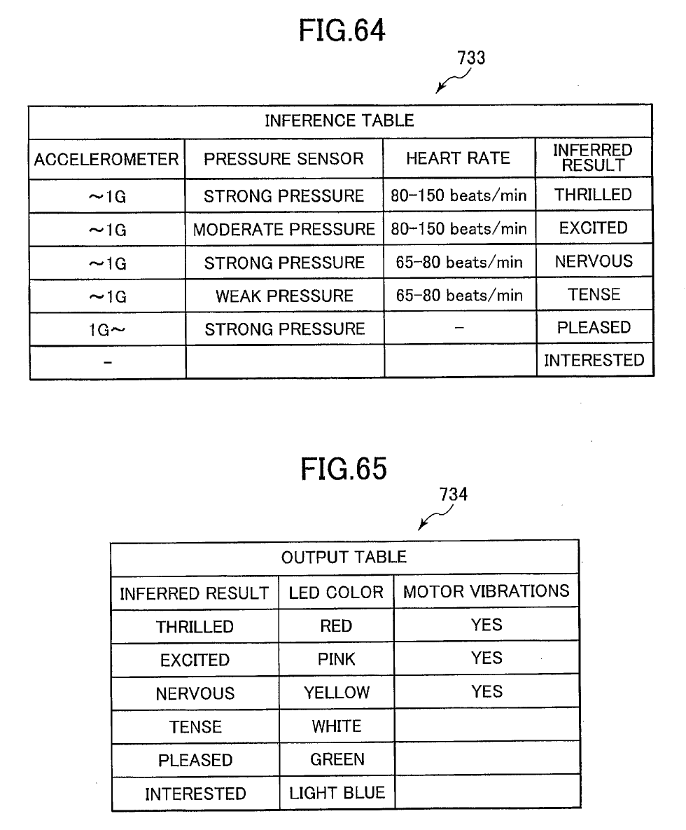

Next, storage areas in the RAM 730 will be described with reference to FIGS. 62 through 65. FIG. 62 is an explanatory diagram showing storage areas in the 730. FIG. 63 is an explanatory diagram showing a configuration of the membrane switch output storage area 731 in the RAM 730. FIG. 64 is an explanatory diagram showing an inference table stored in an inference table storage area 733 of the RAM 730. FIG. 65 is an explanatory diagram showing an output table stored in an output table storage area 734 of the RAM 730.

As shown in FIG. 62, the RAM 730 has a membrane switch output storage area 731 for storing values outputted from each membrane switch 155 of the pressure sensor 16; a measurement value storage area 732 for storing values outputted from the sensors 11-16, 18, 19, and 29; an inference table storage area 733 for storing an inference table used to create inference data (inference results); and an output table storage area 734 storing an output table used to determine output data based on the created inference data.

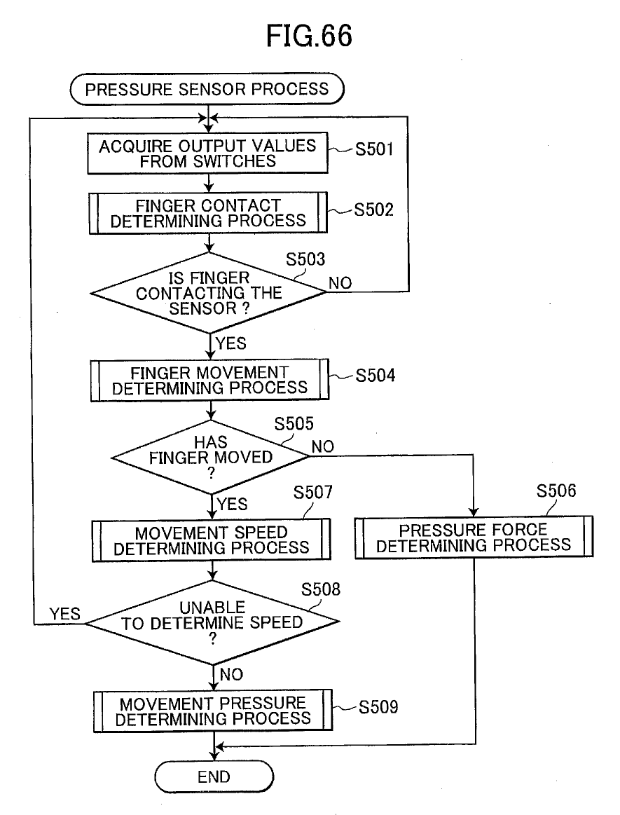

As shown in FIG. 63, the membrane switch output storage area 731 stores the output value 0 or 1 from each membrane switch 155 every 0.01 seconds. In a pressure sensor process described later with reference to FIG. 66, the CPU 10 counts the number of ON values outputted from the membrane switches 155 based on the values stored in the membrane switch output storage area 731 and calculates a change in output values within a prescribed interval.

The inference table storage area 733 shown in FIG. 64 stores an inference table for creating inference data from measurement values outputted by the sensors 11-16, 18, 19, and 29. In the preferred embodiment, the emotions of the user are inferred from measurement values outputted by the accelerometer 12, pressure sensor 16, and heart rate sensor 19. As shown in FIG. 64, the inferred emotion of the user is “thrilled” when the output from the accelerometer 12 is less than 1 G (not shaking), determination results from the pressure sensor 16 are “strong pressure,” and the heart rate is 80-150 beats/minute (high); “excited” when the output from the accelerometer 12 is less than 1 G (not shaking), determination results from the pressure sensor 16 are “moderate pressure,” and the heart rate is 80-150 beats/minute (high); “nervous” when the output from the accelerometer 12 is less than 1 G (not shaking), determination results from the pressure sensor 16 are “strong pressure,” and the heart rate is 65-80 beats/minute (somewhat high); “tense” when the output from the accelerometer 12 is less than 1 G (not shaking), determination results from the pressure sensor 16 are “weak pressure,” and the heart rate is 65-80 beats/minute (somewhat high); “pleased” when the output from the accelerometer 12 exceeds 1 G (shaking), and determination results from the pressure sensor 16 are “strong pressure”; and “interested” for any other combination of measurement values.

In the example of FIG. 64, the emotions of the user are inferred based solely on the pressure of a finger represented by measurement values from the pressure sensor 16, but the emotions may also be inferred from determination results including movement of the finger, as described below. For example, the status communication device 201 may infer that the user “wishes to speak to someone” when rubbing the pressure sensor 16 slowly, the degree to which the user wishes to speak to someone being inferred from the amount of pressure applied. Further, the status communication device 201 may infer that the user is “angry at someone” when rubbing the pressure sensor 16 quickly, the degree of anger being inferred from the amount of pressure applied. Naturally, the emotions of the user may also be inferred by combining this data with other sensor output.

The output table storage area 734 stores an output table used to determine how output to the actuators 21-26 should be performed based on the inference data created with reference to the inference table in FIG. 64. As shown in FIG. 65, output indicated in the output table includes lighting the red LED 21 and vibrating the motor 23 when the result of inference is “thrilled”; lighting the pink LED 21 and vibrating the motor 23 when the result of inference is “excited”; lighting the yellow LED 21 and vibrating the motor 23 when the result of inference is “nervous”; lighting the white LED 21 without vibrating the motor 23 when the result of inference is “tense”; lighting the green LED 21 without vibrating the motor 23 when the result of inference is “pleased”; and lighting the light blue LED 21 without vibrating the motor 23 when the result of inference is “interested.”

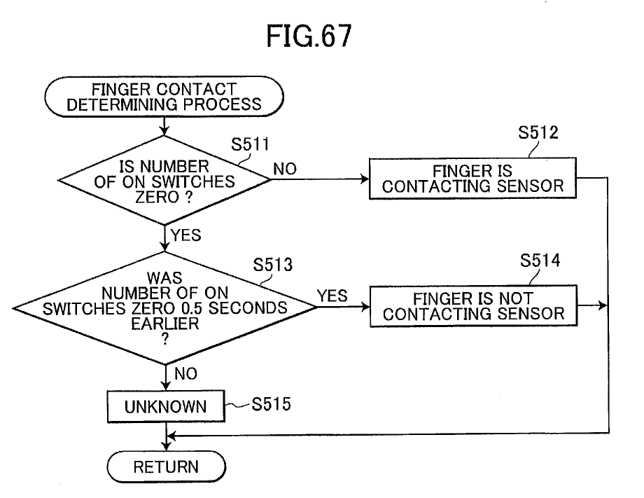

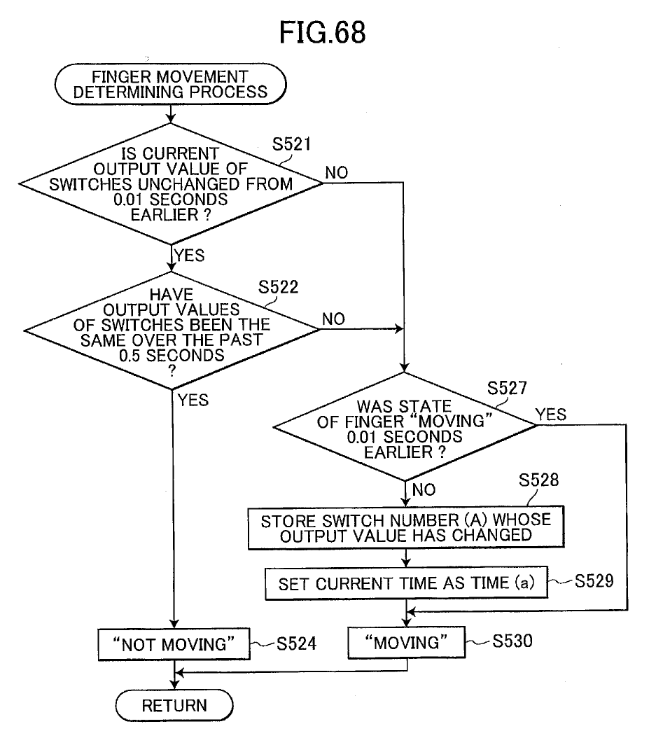

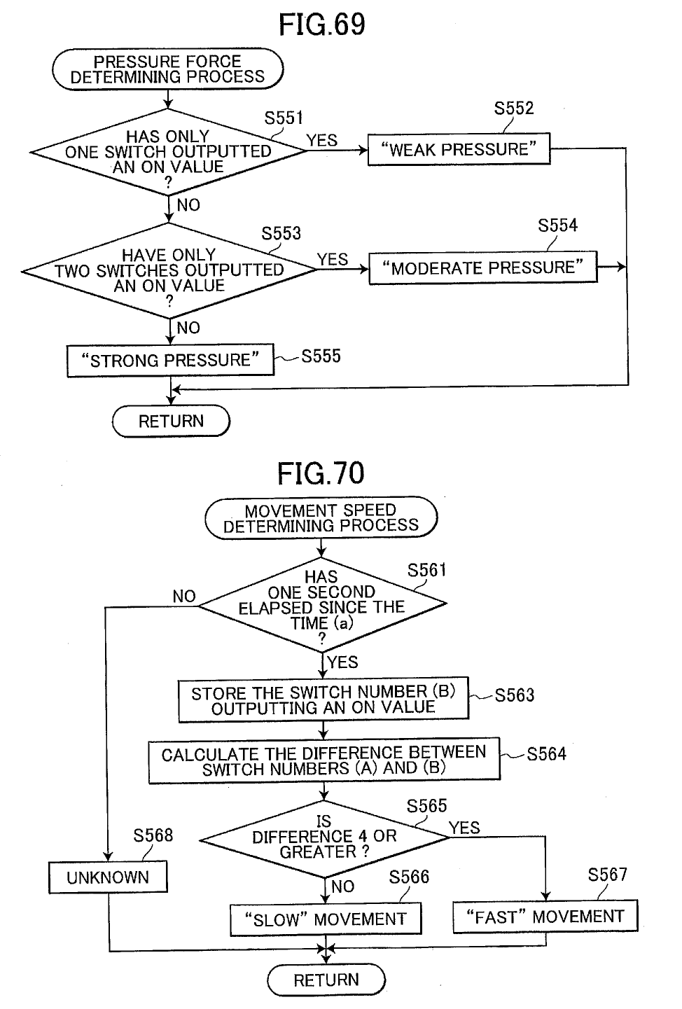

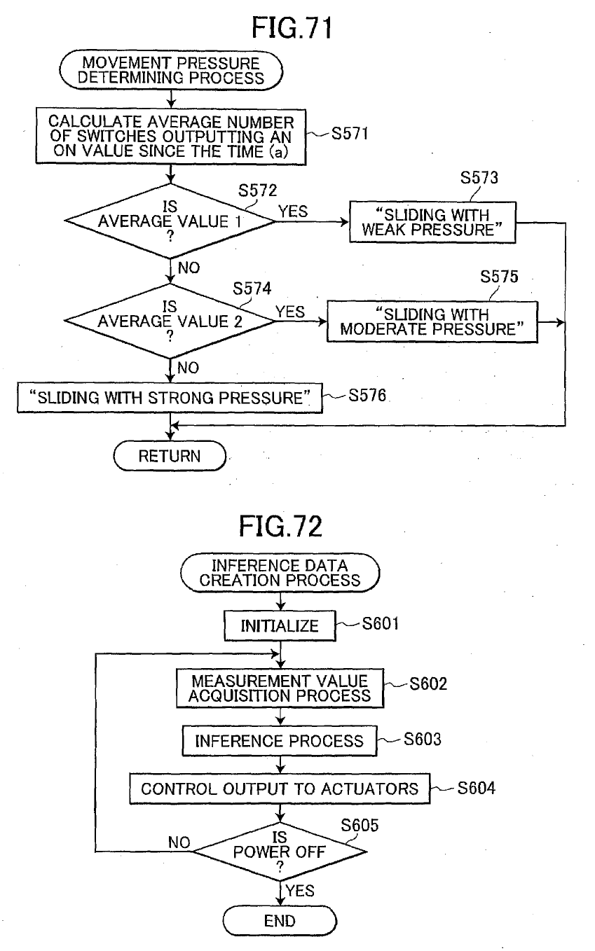

Next, a pressure sensor process will be described with reference to FIGS. 66 through 71. In the pressure sensor process, the CPU 10 detects movement and pressure of a finger touching the pressure sensor 16 based on input signals from the membrane switches 155 of the pressure sensor 15. FIG. 66 is a flowchart illustrating steps in a main routine of the pressure sensor process. FIG. 67 is a flowchart illustrating steps in a subroutine of the pressure sensor process for detecting the presence of a finger. FIG. 68 is a flowchart illustrating steps in a subroutine of the pressure sensor process for detecting movement of the finger. FIG. 69 is a flowchart illustrating steps in a subroutine of the pressure sensor process for determining the amount of pressure applied. FIG. 70 is a flowchart illustrating steps in a subroutine of the pressure sensor process for determining the speed of finger movement. FIG. 71 is a flowchart illustrating steps in a subroutine of the pressure sensor process for determining moving pressure. In the preferred embodiment, the main routine of the pressure sensor process in FIG. 66 is repeatedly executed by the CPU 10 every 0.01 seconds.

In S501 at the beginning of the process in FIG. 66, the CPU 10 acquires an output value (0 or 1) from each of the membrane switches 155 (SW). In S502 the CPU 10 executes the subroutine for detecting whether a finger is touching the pressure sensor 15 based on the output values. This subroutine will be described later in detail with reference to FIG. 67.

In S503 the CPU 10 determines whether the finger is present on the pressure sensor 15 based on the results in S502. For all cases other than a determination that a finger exists on the pressure sensor 15 including the case in which a determination was not possible (see S515 in FIG. 67; S503: NO), the CPU 10 returns to S501 and again acquires the output values. If the CPU 10 determines that the finger is present on the pressure sensor 15 (S503: YES), then in S504 the CPU 10 performs the subroutine to determine whether the finger has moved over the pressure sensor 15. This subroutine will be described later in greater detail with reference to FIG. 68.

In S505 the CPU 10 determines whether the finger has moved over the pressure sensor 15 based on the results in S504. If there is no movement of the finger (S505: NO), then in S506 the CPU 10 performs the subroutine to determine the amount of pressure applied by the unmoving finger, and subsequently ends the pressure sensor process. The subroutine for determining the amount of applied pressure will be described later in greater detail with reference to FIG. 13.

If the finger has moved (S505: YES), then in S507 the CPU 10 executes the subroutine to determine the speed of movement. In S508 the CPU 10 determines whether the speed of movement could be detected based on the results in S507. The subroutine for determining the speed of movement will be described later in greater detail with reference to FIG. 70.

If the speed of movement could not be determined (S508: NO), in S509 the CPU 10 executes the subroutine to determine the amount of pressure applied by the moving finger, and subsequently ends the pressure sensor process. This subroutine will be described later in greater detail with reference to FIG. 71.

As will be described later, the pressure sensor process functions to classify the state of the finger touching the pressure sensor 16 at the current moment in time as “unmoving with weak pressure,” “unmoving with moderate pressure,” “unmoving with strong pressure,” “moving slowly with weak pressure,” “moving slowly with moderate pressure,” “moving slowly with strong pressure,” “moving quickly with weak pressure,” “moving quickly with moderate pressure,” and “moving quickly with strong pressure.” The classification is stored in the RAM 730 as measurement values from the pressure sensor 16.

Next, the subroutine in S502 of the pressure sensor process (FIG. 66) for determining the presence of a finger will be described with reference to FIG. 67. In S511 at the beginning of the subroutine in FIG. 67, the CPU 10 determines whether the number of membrane switches 155 having an ON output value is 0. If any of the membrane switches 155 had an output value of ON (S511: NO), then in S512 the CPU 10 determines that a finger is present on the pressure sensor 15 and returns to the pressure sensor process of FIG. 66. If all of the output values are OFF (S511: YES), then in S513 the CPU 10 determines whether the number of membrane switches 155 outputting a value of ON continuously over the last 0.5 seconds was 0. If all membrane switches 155 outputted a value of OFF over the last 0.5 seconds (S513: YES), then in S514 the CPU 10 determines that no finger is present on the pressure sensor 15, and returns to the pressure sensor process of FIG. 66. However, if even one of the membrane switches 155 outputted an ON value in the preceding 0.5-second interval (S513: NO), then in S515 the CPU 10 determines that the existence of a finger on the pressure sensor 15 is unknown, and returns to the pressure sensor process of FIG. 66.

Next, the subroutine in S504 of the pressure sensor process (FIG. 66) for detecting movement of a finger will be described with reference to FIG. 68. In S521 at the beginning of the subroutine in FIG. 68, the CPU 10 compares the output value of each membrane switch 155 0.01 seconds earlier to the current output value of each membrane switch 155 to determine whether the output values are equivalent for all membrane switches 155. If the output values of all membrane switches 155 are unchanged (S521: YES), then in S522 the CPU 10 determines whether the output values for each membrane switch 155 at 0.01 second intervals over the past 0.5 seconds are equivalent to the current value for the same membrane switch 155. If the output values over the past 0.5 seconds are equivalent to the current value for all membrane switches 155 (S522: YES), then in S534 the CPU 10 determines that the finger is not moving, and returns to the pressure sensor process in FIG. 66.

However, if the output value measured 0.01 seconds earlier differs from the current output value for any of the membrane switches 155 (S521: NO), or if the output value measured 0.01 seconds earlier is equivalent to the current output value for all membrane switches 155 (S521: YES) and at least one of the output values over the past 0.5 seconds differs from the respective current value for at least one of the membrane switches 155 (S522: NO), then in S527 the CPU 10 determines whether the determination made 0.01 seconds earlier (the preceding determination) was “moving.” If the previous determination was “moving” (S527: YES), then in S530 the CPU 10 determines that the current state of the finger is also “moving,” and returns to the pressure sensor process in FIG. 66.

However, if the results of the preceding determination was “unmoving” (S527: NO), indicating that output values of the membrane switch 155 just changed for the first time, then in S528 the CPU 10 stores the switch number (SW number “A”) of the membrane switch 155 whose output value has changed in the RAM 730. If there are a plurality of membrane switches 155 whose output value is ON, then the SW number “A” is set to the average value of the SW numbers. In S529 the CPU 10 stores the current time as a time “a”. In S530 the CPU 10 determines that the state of the finger is “moving” and returns to the pressure sensor process in FIG. 68.

By executing the subroutine for determining movement described above, the CPU 10 determines whether the status of a finger on the pressure sensor 15 is “unmoving” (S524) or “moving” (S530). The results of this determination are stored in the RAM 730.

Next, the subroutine in S506 of the pressure sensor process (FIG. 66) for determining the amount of pressure applied by the finger will be described with reference to FIG. 69. The subroutine for determining the amount of applied pressure is executed when the CPU 10 determines that the finger is “unmoving” in the subroutine of FIG. 68. In S551 at the beginning of the subroutine shown in FIG. 69, the CPU 10 determines whether only one membrane switch 155 has outputted an ON value. If only one membrane switch 155 has outputted an ON value (S551: YES), then in S552 the CPU 10 determines that the amount of pressure is “weak pressure” and returns to the pressure sensor process of FIG. 66.

However, if more than one membrane switch 155 has outputted an ON value (S551: NO), then in S553 the CPU 10 determines whether only two membrane switches 155 have outputted an ON value. If two membrane switches 155 have outputted an ON value (S553: YES), then in S554 the CPU 10 determines that the amount of pressure is “moderate pressure” and returns to the pressure sensor process of FIG. 66.

However, if the number of membrane switches 165 outputting an ON value is greater than two (S553: NO), indicating that at least three membrane switches 165 are ON, then in S555 the CPU 10 determines that the amount of pressure is “strong pressure” and returns to the pressure sensor process of FIG. 66.

Through the subroutine for determining the amount of applied pressure described above, the CPU 10 can determine the force that an unmoving finger applies to the pressure sensor 15 based on the number of membrane switches 155 outputting an ON value.

Next, the subroutine for determining the speed of movement executed in S507 of the pressure sensor process in FIG. 66 will be described with reference to FIG. 70. In S561 at the beginning of the subroutine for determining the speed of movement in FIG. 70, the CPU 10 determines whether 1 second has elapsed since the time “a” set in S529 of FIG. 68 during the previous pressure sensor process. If 1 second has not yet elapsed (S561: NO), then in S568 the CPU 10 sets the speed of movement to “unknown” are returns to the pressure sensor process of FIG. 66.

If 1 second has elapsed after the time “a” (S561; YES), then in S563 the CPU 10 stores the switch number (SW number B) for the membrane switch 155 currently outputting an ON value in the RAM 730. If there are a plurality of membrane switches 155 outputting an ON value, then the SW number B is set to the average value of SW numbers, as described for the SW number A in S528 of FIG. 68. In S564 the CPU 10 calculates the difference between the SW number A and SW number B, i.e., the amount of movement.

In S565 the CPU 10 determines whether the difference calculated in S564 is 4 or greater. If the difference is less than 4 (S565: NO), then in S566 the CPU 10 sets the speed of movement to “slow” and returns to the pressure sensor process of FIG. 66. However, if the difference is 4 or greater (S565: YES), then in S567 the CPU 10 determines the speed of movement to be “quick” and returns to the pressure sensor process of FIG. 66.

Through the subroutine for determining the speed of movement described above, the CPU 10 can find the speed of movement of the finger determined to be “moving” over the pressure sensor 15 by calculating the amount that the position of membrane switches 155 outputting ON signal changes within 1 second.

Next, the subroutine for determining applied pressure during movement executed in the pressure sensor process will be described with reference to FIG. 71. As described above, the subroutine applied pressure during movement is executed after determining the finger is “moving” and subsequently after determining the speed of movement. In S571 at the beginning of the subroutine shown in FIG. 71, the CPU 10 finds the average number of membrane switches 155 having an ON output value calculated every 0.01 seconds from time “a” set in S529 of FIG. 68 to the current time. The average value is set to an integer value by rounding off any numbers to the right of the decimal.

In S572 the CPU 10 determines whether the average value found in S571 is 1. If the average value is 1 (S572: YES), then in S573 the CPU 10 determines that the applied pressure during movement is “moving with weak pressure,” and returns to the pressure sensor process of FIG. 66.

However, if the average value is not 1 (S572: NO), then in S574 the CPU 10 determines whether the average value is 2. If the average value is 2 (S574: YES), then in S575 the CPU 10 determines that the applied pressure during movement is “moving with moderate pressure,” and returns to the pressure sensor process of FIG. 66.

However, if the average value is neither 1 nor 2 (S574: NO), indicating that the average value is 3 or greater, then in S576 the CPU 10 determines that the applied pressure during movement is “moving with strong pressure,” and returns to the pressure sensor process of FIG. 66.

Through the subroutine for determining applied pressure during movement described above, the CPU 10 can determine the force applied by a finger determined to be “moving” over the pressure sensor 15 based on the average number of membrane switches 155 outputting an ON value during a movement of the finger.

Next, an inference data creation process will be described with reference to FIG. 72. With this process, inference data is created using measurement values from the sensors 11-16, 18, 19, and 29, including the measurement values obtained in the pressure sensor process of FIG. 66. FIG. 72 is a flowchart illustrating steps in the inference data creation process. The CPU 10 of the status communication device 201 starts an inference data creation program when power supplied from a battery (not shown) in the status communication device 201 is turned on to continually executed the inference data creation process according to the preferred embodiment.

In S601 of the inference data creation process shown in FIG. 72, the CPU 10 initializes various data, flags, and the like. For example, the CPU 10 initializes the measurement value storage area 732 in the RAM 730 storing measurement values outputted by the sensors 11-16, 18, 19, and 29, and clears a counter for counting the number of user gestures.

Once initialization in S601 is complete, the sensors 11-16, 18, 19, and 29 begin conducting measurements, the sensors 11-16, 18, 19, and 29 executing measurements continuously during the inference data creation process. Measurement values from the sensors are stored in the measurement value storage area 732 of the RAM 730 at prescribed intervals (5 seconds, for example), thereby updating the measurement values stored in the measurement value storage area 732 at these prescribed intervals.

In S602 the CPU 10 performs a process to read and acquire measurement values outputted by the sensors 11-16, 18, 19, and 29 from the measurement value storage area 732. In S603 the CPU 10 performs an inference process to calculate index data for inferring emotions (inference data) by referencing the inference table stored in the inference table storage area 733 of the RAM 730 based on the measurement values acquired in S602. For example, if the output from the accelerometer 12 is less than 1 G, indicating that the status communication device 201 is not being shaken, determination results from the pressure sensor is “moderate pressure,” and the heart rate is 80-150 beats/minute (high), then the inference data acquired by referencing the inference table is “excited” (see FIG. 64).

Next, the CPU 10 sets output data for the actuators by referencing the output table stored in the output table storage area 734 of the RAM 730 (see FIG. 65) based on the inference data acquired in S603. In S604 the CPU 10 transmits command signals to the motor 23, LEDs 21, or other actuators based on the output data determined above. Hence, if the inference data is “excited,” as in the above example, the pink LED 21 is controlled to output light, and the motor 23 is vibrated.

In S605 the CPU 10 determines whether the power has been turned off. The CPU 10 ends the inference data creation process if the power has been turned off (S605: YES) and returns to S602 to repeat the process if the power has not been turned off (S605: NO).

With the pressure sensor 15 according to the preferred embodiment described above, output values (“0” or “1”) from each membrane switch 155 are measured every 0.01 seconds, enabling the status communication device 201 to measure the position of a finger pressing the pressure sensor 15 at any point in time. Further, by arranging the membrane switches 155 at substantially equal intervals and counting the number of membrane switches 155 that are on at a point in time, it is possible to measure the force in which a finger is pressing against the pressure sensor 15 since a stronger pushing force will turn on a larger number of membrane switches 155 over a wider range. Further, by storing the above measurements in a time series, it is possible to measure the speed of movement in a finger when the positions of membrane switches 155 outputting an ON signal change by calculating the rate of change in these positions over a second. Since such detailed measurement values can be obtained from the pressure sensor 15, the pressure sensor 15 expands the range of inference possible with the status communication device 201, enabling the status communication device 201 to obtain and output more detailed and precise inference results.

As with the status communication devices 1 and 101 according to the first and second embodiments, the status communication device 201 according to the third embodiment can receive inference results based on the pressure sensor 15 of another status communication device 201 via the transceiver 50, select a single state from the plurality of inference results using one of the first through seventh state displaying methods, and display this state with the LEDs 21. Accordingly, the status communication device 201 can obtain the same effects as the status communication devices 1 and 101 in the first and second embodiments described above.

While the status communication device and status communication program of the present invention has been described in detail with reference to specific embodiments thereof, it would be apparent to those skilled in the art that many modifications and variations may be made therein without departing from the spirit of the invention, the scope of which is defined by the attached claims. For example, while output data is stored in the ROM 20 in the first embodiment described above, the output data may be rewritably stored in the RAM 30 rather than the ROM 20. Further, the user may be provided with a menu for setting display colors for each state to desired colors. Further, the types of states are not limited to the six user states described above, but may include other states. The user may be allowed to enter such states. Further, while only the LEDs 21 are used to indicate states in the first embodiment, it is also possible to use the flashlamp 22, motor 23, heater 24, and speaker 25, or a combination thereof.

Further, while the state having the highest level is selected in the third state displaying method according to the first embodiment, the state having the lowest level may be selected instead. This may be achieved by storing state numbers in the level storage area in order from the lowest level, or by using the level storage area 123 shown in FIG. 17 with state numbers arranged in order from the highest level, setting the state counter K to the maximum state number in S32 of the determination process shown in FIG. 18, and decrementing the state counter K by status communication device 1 in S36. Alternatively, this method may be configured to select both the state having the highest level and the state having the lowest level and to display the two alternatingly. The status communication device 1 may be configured to allow the user to select whether to display the state having the highest level or the state having the lowest level.

In the fourth state displaying method described in the first embodiment, the weighting coefficient storage area 124 is provided in the ROM 20, but the weighting coefficient storage area 124 may be rewritably stored in the RAM 430 rather than the ROM 20, and the user may be provided with a menu for setting weighting coefficients for each state to desired values.

In the fifth state displaying method according to the first embodiment, the status communication device selects the state indicated by the initially received index data, but the status communication device may instead select index data received last. In this case, it is not necessary to determine whether a reception has been completed in S53 of the reception process shown in FIG. 22.

Further, while the reception number is counted for each state in the third state displaying method according to the first embodiment, since the state having the highest level is selected, it is possible to simply provide a flag indicating whether index data was received for that state, without counting the reception number.

Further, the user may be allowed to select one of the first through seventh state displaying methods described in the first embodiment and variations of these methods as the method of selecting index data to be displayed. When allowing the user to input a selection in this way, sensor values (values outputted by the accelerometer 12 and bending sensor 11, for example) for indicating input by the user may be prestored, and the status communication device may identify the number of times the user shakes or grips the status communication device (user gestures) in order to determine whether the user has performed input prior to executing the emotions/environment inferring process (S103) in the main output process (see FIG. 11). The status communication device performs a corresponding process when determining that the user has inputted a selection, and performs the emotions/environment inferring process when determining that the user has not inputted a selection. User input used for performing the corresponding process is determined by a user gesture.

Further, while sensor values are discarded in the second embodiment if the corresponding actuators are operating, the values measured by the sensors may be included with a flag indicating that the actuator corresponding to the sensor is operating.

In the third embodiment described above, the status communication device 201 calculates the difference between the SW number A and SW number B, indicating the amount of movement, and compares the amount of movement to a threshold value to find the speed of movement. However, the status communication device 201 may also find the speed of movement by calculating the actual movement distance in 1 second in FIG. 70 based on the distance between the switches SW.

In the third embodiment, the status communication device 201 determines that the pressure applied by the finger is “weak pressure” when only one of the membrane switches 155 is on, “moderate pressure” when two of the membrane switches 155 are on, and “strong pressure” when three or more of the membrane switches 155 are on. However, the degree of pressure applied by a finger may be determined based on different numbers of membrane switches 155 outputting an ON value.

Further, while the classifications “unmoving with weak pressure,” “unmoving with moderate pressure,” “unmoving with strong pressure,” “moving slowly with weak pressure,” “moving slowly with moderate pressure,” “moving slowly with strong pressure,” “moving quickly with weak pressure,” “moving quickly with moderate pressure,” and “moving quickly with strong pressure” determined with the pressure sensor 16 are used solely for inferring emotions in the preferred embodiment. However, these classifications may also be used as nine switches in a mobile device, for example.

The present invention can be applied to a status communication device and a status communication program for receiving data from a plurality of other status communication devices or for receiving a plurality of data from a single status communication device.

What is claimed is:

1. A status communication device comprising:
a housing;
at least one measuring unit that measures biological data of a user and an ambient state of the housing;
at least one state displaying unit that displays a state of the user or the ambient state of the housing;
a transmitting unit that transmits first measurement-related data to at least one external device, the first measurement-related data being measurement data measured by the measuring unit or data based on the measurement data;
a receiving unit that receives second measurement-related data from at least one external device;
a data selecting unit that selects one state corresponding to the second measurement-related data to display with the state displaying unit if the receiving unit receives a plurality of the second measurement-related data within a prescribed interval; and
a state display controlling unit that controls the state displaying unit based on the second measurement-related data selected by the data selecting unit.

2. The status communication device according to claim 1, wherein the data selecting unit comprises a counting unit that counts each type of the second measurement-related data received by the receiving unit within the prescribed interval; and selects the second measurement-related data having the greatest number counted by the counting unit.

3. The status communication device according to claim 1, wherein the data selecting unit comprises:
a counting unit that counts each type of the second measurement-related data received by the receiving unit within the prescribed interval;
a level storing unit that stores weighted levels applied to each second measurement-related data in association with the second measurement-related data;
a level product calculating unit that calculates level products by multiplying a counted value counted by the counting unit with the level stored in the level storing unit for each of the second measurement-related data;
an average calculating unit that calculates an average of the level products calculated by the level product calculating unit; and
a nearest value determining unit that determines the level having a nearest value to the average value calculated by the average calculating unit;
wherein the data selecting unit selects the second measurement-related data having the level determined to be the nearest value by the nearest value determining unit.

4. The status communication device according to claim 1, wherein the data selecting unit comprises:
a counting unit that counts each type of the second measurement-related data received by the receiving unit within the prescribed interval;
a level storing unit that stores weighted levels assigned to each of the second measurement-related data in association with the second measurement-related data; and
a level determining unit that determines data having a largest level or data having a smallest level among the second measurement-related data received by the receiving unit;
wherein the data selecting unit selects the second measurement-related data determined to have the largest level or the smallest level by the level determining unit.

5. The status communication device according to claim 1, wherein the data selecting unit comprises:
a counting unit that counts each type of the second measurement-related data received by the receiving unit within the prescribed interval;
a weighted coefficient storing unit that stores weighted coefficients assigned to each of the second measurement-related data in association with the second measurement-related data; and
a weighted coefficient product calculating unit that calculates products of a counted value counted by the counting unit and the weighted coefficient for each of the second measurement-related data;
wherein the data selecting unit selects the second measurement-related data corresponding to a largest product among products calculated by the weighted coefficient product calculating unit.

6. The status communication device according to claim 1, wherein the data selecting unit selects the second measurement-related data received first by the receiving unit within the prescribed interval.

7. The status communication device according to claim 1, wherein the transmitting unit transmits first ID data together with the first measurement-related data, the first ID data distinguishing the status communication device from other status communication devices;
wherein the receiving unit receives second ID data together with the second measurement-related data;
wherein the data selecting unit comprises an ID counting unit that counts the number of second measurement-related data received by the receiving unit within the prescribed interval for each second ID data; and
wherein the data selecting unit selects the second measurement-related data received last among ID data having a highest number counted by the ID counting unit.

8. The status communication device according to claim 1, wherein the transmitting unit transmits first ID data together with the first measurement-related data, the first ID data distinguishing the status communication device from other status communication devices;
the receiving unit receives second ID data together with the second measurement-related data;
the data selecting unit comprises a reception interval time measuring unit that calculates a time, as the reception interval time, between a preceding reception and a current reception of the second measurement-related data having same second ID data if second measurement-related data having the same second ID data is received within the prescribed interval; and
the data selecting unit selects the second measurement-related data having the second ID data with a shortest reception interval time between receptions calculated by the reception interval time measuring unit.

9. The status communication device according to claim 1, further comprising index data creating unit that creates first index data functioning as data related to the state of a user or the ambient state of the housing based on the measurement data;
wherein the transmitting unit transmits the first index data as the first measurement-related data to at least one external device;
wherein the receiving unit receives second index data as the second measurement-related data from at least one external device; and
wherein the state display controlling unit controls the state displaying unit based on the first index data.

10. The status communication device according to claim 9, wherein the index data creating unit comprises:
an index data determining procedure storing unit that stores an index data determining procedure used to determine the first index data; and
an index data determining unit that determines the first index data from the measurement data based on the index data determining procedure, and
wherein the state display controlling unit comprises:
a control data determining procedure storing unit that stores control data determining procedures used to determine control data for controlling the state displaying unit based on the first index data; and
a control data determining unit that determines the control data from the first index data according to the control data determining procedure stored in the control data determining procedure storing unit.

11. The status communication device according to claim 1, further comprising:
a detecting unit that detects the state displaying unit that is operating;
a first index data determining procedure storing unit that stores a first index data determining procedure used to determine index data, the index data being data related to the state of a user or the ambient state of the housing, based on the measurement data measured by the measuring unit if the detecting unit does not detect operations of the state displaying unit;
a second index data determining procedure storing unit that stores a second index data determining procedure used to determine the index data without using the measurement data measured by the measuring unit if the detecting unit detects operations of the state displaying unit;
an index data creating unit that creates the index data according to the first index data determining procedure or the second index data determining procedure; and
a state display controlling unit that controls the state displaying unit according to the index data created by the index data creating unit.

12. The status communication device according to claim 11, wherein the second index data determining procedure storing unit comprises a measurement controlling unit that controls the measurement data measured by the measuring unit based on detection results by the detecting unit.

13. The status communication device according to claim 12, further comprising a correlation storing unit that stores correlations between the state displaying unit and the measuring unit whose measurement data are affected by operations of the state displaying unit;
wherein the measurement controlling unit reads from the correlation storing unit the measuring unit corresponding to the state displaying unit that is currently operating if the detecting unit detects that one of the state displaying units is operating, and discards measurement data measured by the read measuring unit.

14. The status communication device according to claim 12, further comprising a correlation storing unit that stores correlations between the state displaying unit and the measuring unit whose measurement data are affected by operations of the state displaying unit;
wherein the measurement controlling unit reads from the correlation storing unit the measuring unit corresponding to the state displaying unit that are currently operating if the detecting unit detects that one of the state displaying units is operating, and prevents the read measuring unit from performing measurements.

15. The status communication device according to claim 11, wherein the second index data determining procedure storing unit stores a third index data determining procedure that determines the index data using measurement data measured by the measuring unit prior to operations of the state displaying unit rather than during operations of the state displaying unit.

16. The status communication device according to claim 1, further comprising an index data determining procedure storing unit that stores the index data determining procedures used to determine index data, the index data being data related to the state of a user or the ambient state of the housing, based on the measurement data measured by the measuring unit;
an index data creating unit that creates the index data from the measurement data based on the index data determining procedures;
a state display controlling unit that controls the state displaying unit based on the index data created by the index data creating unit;
a detecting unit that detects the state displaying unit that are currently operating;
a measurement controlling unit that controls the measurement data measured by the measuring unit based on detection results by the detecting unit; and
an index data creation controlling unit that controls the index data creating unit if the measurement controlling unit controls the measurement data.

17. The status communication device according to claim 16, further comprising a correlation storing unit that stores correlations between the state displaying unit and the measuring unit whose measurement results are affected by operations of the state displaying unit;
wherein the measurement controlling unit reads from the correlation storing unit the measuring unit corresponding to the state displaying unit that is currently operating if the detecting unit detects that one of the state displaying units is operating, and discards measurement data measured by the read measuring unit.

18. The status communication device according to claim 17, wherein the index data creation controlling unit controls the index data creating unit to use valid measurement data in place of the discarded measurement data if the measurement data measured by the read measuring unit is discarded.

19. The status communication device according to claim 17, wherein the index data creation controlling unit controls the index data creating unit to create the index data from the measurement data other than the discarded measurement data based on the index data determining procedures if the measurement data measured by the read measuring unit is discarded.

20. The status communication device according to claim 17, further comprising special index data determining procedure storing unit that stores special index data determining procedures corresponding to types of the measurement data and used if the measurement data measured by the read measuring unit is discarded;
wherein the index data creation controlling unit controls the index data creating unit to create index data based on the special index data determining procedures corresponding to the measurement data if the measurement data measured by the read measuring unit is discarded.

21. The status communication device according to claim 16, further comprising a correlation storing unit that storing correlations between the state displaying unit and the measuring unit whose measurement results are affected by operations of the state displaying unit;
wherein the measurement controlling unit reads from the correlation storing unit the measuring unit corresponding to the state displaying unit that is currently operating if the detecting unit detects that one of the state displaying units is operating, and prevents the read measuring unit from performing measurements.

22. The status communication device according to claim 21, wherein the index data creation controlling unit controls the index data creating unit to use valid measurement data in place of the unmeasured measurement data if the measurement data measured by the read measuring unit is not measured.

23. The status communication device according to claim 21, wherein the index data creation controlling unit controls the index data creating unit to create the index data from measurement data other than the unmeasured measurement data based on the index data determining procedures if the measurement data measured by the read measuring unit is not measured.

24. The status communication device according to claim 21, further comprising special index data determining procedure storing unit that stores special index data determining procedures corresponding to types of the measurement data and used if the measurement data measured by the read measuring unit is not measured;
wherein the index data creation controlling unit controls the index data creating unit to create index data based on the special index data determining procedures corresponding to the measurement data if the measurement data measured by the read measuring unit is not measured.

25. The status communication device according to claim 1, wherein the measuring unit has a pressure sensor comprising:
a membrane sheet comprising a pair of insulating sheets having opposing surfaces with each other, electrode pairs disposed on the opposing surfaces, and insulating spacers interposed between the insulating sheets, thereby constituting a plurality of membrane switches that conduct electricity if pressure causes the electrode pairs to come near or contact each other; and
a counting unit that counts the number of the membrane switches in the membrane sheet that conducts electricity.

26. The status communication device according to claim 25, further comprising a plurality of display units provided corresponding to the plurality of membrane switches respectively and disposed adjacent to the plurality of membrane switches that indicates the membrane switches conducting electricity.

27. The status communication device according to claim 25, further comprising a pressure determining unit that determines that pressure on the pressure sensor is stronger if the number of membrane switches counted by the counting unit is greater.

28. The status communication device according to claim 25, wherein the counting unit counts the number of membrane switches in the membrane sheet conducting electricity at prescribed intervals;
the status communication device further comprising movement determining unit that determines that a position of pressure on the membrane sheet is moving if a conducting state of any of the membrane switches of the membrane sheets in one prescribed interval is different from that of another prescribed interval prior to the one prescribed interval.

29. The status communication device according to claim 25, further comprising:
a movement amount calculating unit that calculates a movement amount from the current positions of the membrane switches in the membrane sheet conducting electricity to the positions of the membrane switches conducting electricity a prescribed time earlier if the movement determining unit determines that the position of pressure on the membrane sheet is moving; and
a movement speed determining unit that determines a speed in which the pressure position is moving over the membrane sheet based on the movement amount calculated by the movement amount calculating unit.

30. A storage medium storing a status communication program readable by a computer, the status communication program comprising:
instructions for measuring biological data of a user and an ambient state of the computer;
instructions for displaying the state of the user or the ambient state of the computer on a state displaying unit;
instructions for transmitting first measurement-related data, which is measurement data measured by the measuring instructions or data based on the measurement data, to at least one external device;
instructions for receiving second measurement-related data from at least one external device in a receiving unit;
instructions for controlling the state displaying unit based on the second measurement-related data; and
instructions for selecting one state corresponding to the second measurement-related data to display with the state displaying unit if the receiving unit receives the plurality of the second measurement-related data within a prescribed interval;
wherein the controlling instructions include controlling the state displaying unit based on the second measurement-related data selected by the data selecting unit.
